(19) United States
(12) Patent Application Publication
(10) Pub. No.: US 2026/0035612 A1
(43) Pub. Date: Feb. 5, 2026

(54) FLUORESCENT PARTICLES COMPRISING CARBON DOTS

(71) Applicant: THE HONG KONG POLYTECHNIC UNIVERSITY, Hong Kong (CN)

(72) Inventors: Pei LI, Hong Kong (CN); Ho Chun WONG, Hong Kong (CN); Leong Ting NG, Hong Kong (CN)

(21) Appl. No.: 18/791,512

(22) Filed: Aug. 1, 2024

(51) Int. Cl. C09K 11/02; C09K 11/65

(52) U.S. Cl. CPC C09K 11/025; C09K 11/65

(57) ABSTRACT

Fluorescent core-shell particles comprising a core, a first shell disposed on a surface of the core, and a second shell disposed on a surface of the first shell, wherein the core comprises a first polymer selected from a group consisting of a poly(alkyl acrylate), a poly(alkyl methacrylate), and copolymers thereof, the first shell comprises a first polyamine and a second polymer selected from a group consisting of a poly(alkyl acrylate), a poly(alkyl methacrylate), and copolymers thereof, and the second shell comprises a second polyamine and a plurality of carbon dots, wherein at least a portion of the first polyamine is grafted to the second polymer; methods of use and preparation thereof.

### TECHNICAL FIELD

The present disclosure relates to fluorescent core-shell particles and methods of preparation and use thereof.

### BACKGROUND

Fluorescent particles have attracted considerable attention due to potential applications in bioimaging, sensing, energy-saving technologies and as additives. However, conventional fluorescent particles, especially those based on inorganic particles like semiconductors and quantum dots, often face limitations in terms of stability, photoluminescent performance, dispersibility in water, and potential toxicity concerns.

Many fluorescent particles based on inorganic particles tend to suffer from stability issues, particularly in aqueous environments. Aggregation of the particles over time can lead to a loss of fluorescence and degrade long-term performance.

Achieving good dispersibility and stability of inorganic particles in water can be challenging. Surface modifications or the use of surfactants may be required to enhance dispersibility, which can introduce additional complexity to the particle synthesis process.

Some inorganic particles used in fluorescent particles, such as certain quantum dots and rare earth metals, may raise concerns regarding their potential toxicity. The presence of heavy metals or other elements in these particles could have adverse effects on biological systems or the environment, limiting their suitability for certain applications.

There is thus a need to develop improved fluorescent particles that overcome at least some of the aforementioned challenges.

### SUMMARY

Provided herein are fluorescent core-shell particles that incorporate carbon dots within a hydrophilic polymer shell using organic acid as a carbon source. By utilizing mild reaction conditions and organic acid as a carbon source, a simpler and more environmentally friendly method for synthesizing fluorescent particles with enhanced stability in water and photoluminescent performance is provided.

The resulting fluorescent core-shell particles containing uniformly distributed carbon dots on the particle shell layer exhibit excellent water dispersibility, which is essential for their practical applications in aqueous systems. Furthermore, the use of carbon dots as the fluorophore offers advantages such as reduced toxicity concerns compared to certain inorganic particles. These advancements address the limitations faced by conventional fluorescent particles and open up new possibilities for their use in various fields while mitigating concerns related to dispersibility, stability, and toxicity.

In a first aspect, provided herein is a fluorescent core-shell particles comprising a core, a first shell disposed on a surface of the core, and a second shell disposed on a surface of the first shell, wherein the core comprises a first polymer selected from a group consisting of a poly(alkyl acrylate), a poly(alkyl methacrylate), a poly(alkyl acrylamide), a polyacrylonitrile, a polyacetate, and copolymers thereof; the first shell comprises a first polyamine and a second polymer selected from a group consisting of a poly(alkyl acrylate), a poly(alkyl methacrylate), a poly(alkyl acrylamide), a polyacrylonitrile, a polyacetate, and copolymers thereof, and the second shell comprises a second polyamine and a plurality of carbon dots, wherein at least a portion of the first polyamine is grafted to the second polymer.

In certain embodiments, each of the first polymer and the second polymer is independently selected from a poly(C₁-C₆ alkyl acrylate), poly(C₁-C₆ alkyl methacrylate), and a copolymer thereof.

In certain embodiments, each of the first polymer and the second polymer is independently selected from a poly(methyl methylacrylate) and a poly(methyl methacrylate-co-butyl acrylate).

In certain embodiments, each of the first polyamine and the second polyamine is independently selected from the group consisting of polyethyleneimine, chitosan, casein, gelatine, bovine serum albumin, and a mixture thereof.

In certain embodiments, each of the first polyamine and the second polyamine is independently a polyethyleneimine having a weight average molecular weight of 1,000-1,000,000 kDa.

In certain embodiments, each of the first polyamine and the second polyamine is independently a polyethyleneimine having a weight average molecular weight of 25,000-750,000 kDa.

In certain embodiments, the plurality of carbon dots is prepared by hydrothermal treatment of an organic acid.

In certain embodiments, the organic acid is selected from the group consisting of malic acid, maleic acid, tartaric acid, citric acid, an amino acid, ethylenediaminetetraacetic acid, HO₂C(CH2)ₘCO₂H, wherein m is whole number selected from 0-10, and mixtures thereof.

In certain embodiments, the organic acid comprises citric acid.

In certain embodiments, each of the first polymer and the second polymer is selected from a poly(methyl methylacrylate) and poly(methyl methacrylate-co-butyl acrylate); each of the first polyamine and the second polyamine is independently a polyethyleneimine having a weight average molecular weight of 1,000-1,000,000 kDa; and the plurality of carbon dots is prepared by hydrothermal treatment of an organic acid selected from the group consisting of malic acid, maleic acid, tartaric acid, citric acid, an amino acid, ethylenediaminetetraacetic acid, HO₂C(CH2)ₘCO₂H, wherein m is whole number selected from 0-10, and mixtures thereof.

In certain embodiments, each of the first polymer and the second polymer is selected from a poly(methyl methylacrylate) and a poly(methyl methacrylate-co-butyl acrylate); each of the first polyamine and the second polyamine is independently a polyethyleneimine having a weight average molecular weight of 25,000-750,000 kDa; and the plurality of carbon dots are prepared by hydrothermal treatment of oxalic acid, malic acid, citric acid, ethylenediaminetetraacetic acid, succinic acid, glutaric acid, maleic acid, or a mixture thereof.

In certain embodiments, the plurality of carbon dots is prepared by hydrothermal treatment of citric acid.

In certain embodiments, the hydrothermal treatment of the organic acid is conducted in the presence of core-shell particle precursors comprising a first shell disposed on a surface of a core, and a second shell disposed on a surface of the first shell, wherein the core comprises a first polymer selected from a group consisting of a poly(alkyl acrylate), a poly(alkyl methacrylate), and copolymers thereof, and the second shell comprises a second polyamine and a second polymer selected from a group consisting of a poly(alkyl acrylate), a poly(alkyl methacrylate), and copolymers thereof, wherein at least a portion of the second polyamine is grafted to the second polymer, wherein the organic acid is contacted with the core-shell particle precursors at 10-30 mol % of organic acid relative to the polyamine present in the core-shell particle precursors.

In certain embodiments, each of the first polymer and the second polymer are a poly(methyl methylacrylate), each of the first polyamine and the second polyamine is polyethyleneimine, and the fluorescent core-shell particles comprise polyethyleneimine and the poly(methyl methylacrylate) in a weight ratio of about 1 to about 0.5, respectively; or each of the first polymer and the second polymer are a poly(methyl methacrylate-co-butyl acrylate), each of the first polyamine and the second polyamine is polyethyleneimine, and the fluorescent core-shell particles comprise polyethyleneimine and the poly(methyl methacrylate-co-butyl acrylate) in a weight ratio of about 1 to about 0.5, respectively.

In certain embodiments, each of the first polymer and the second polymer are a poly(methyl methacrylate-co-butyl acrylate) comprising methyl methacrylate and butyl acrylate in a weight ratio between 9:1 to 1:1, respectively.

In certain embodiments, the hydrothermal treatment of citric acid is conducted in the presence of core-shell particle precursors comprising a first shell disposed on a surface of a core, and a second shell disposed on a surface of the first shell, wherein the core comprises a poly(methyl methacrylate-co-butyl acrylate); the second shell comprises polyethyleneimine and poly(methyl methacrylate-co-butyl acrylate); and the second shell comprises polyethyleneimine, wherein at least a portion of the polyethyleneimine in the second shell is grafted to the poly(methyl methacrylate-co-butyl acrylate) in the first shell, wherein the citric is contacted with the core-shell particle precursors at about 20 mol % of citric acid relative to the polyethyleneimine present in the core-shell particle precursors.

In a second aspect, provided herein is a method of preparing the fluorescent core-shell particles described herein, the method comprising: contacting a first olefin selected from an alkyl acrylate, an alkyl methacrylate an alkyl acrylamide, vinyl nitrile, and a vinylacetate, optionally a second olefin selected from an alkyl acrylate, an alkyl methacrylate, an alkyl acrylamide, vinyl nitrile, and a vinylacetate, a polyamine, and a radical initiator thereby forming core-shell particle precursors comprising: a first shell disposed on a surface of a core and a second shell disposed on a surface of the first shell, wherein the core comprises a first polymer selected from a group consisting of a poly(alkyl acrylate), a poly(alkyl methacrylate), a poly(alkyl acrylamide), a polyacrylonitrile, a polyacetate, and copolymers thereof, the first shell comprises the polyamine and a second polymer selected from a group consisting of a poly(alkyl acrylate), a poly(alkyl methacrylate), a poly(alkyl acrylamide), a polyacrylonitrile, a polyacetate, and copolymers thereof; and the second shell comprises the polyamine, wherein at least a portion of the polyamine in the first shell is grafted to the second polymer; contacting the core-shell particle precursors with an organic acid thereby forming a reaction mixture; and subjecting the reaction mixture to hydrothermal conditions resulting in the formation of the plurality of carbon dots in the second shell and thereby forming the fluorescent core-shell particles.

In certain embodiments, each of the first olefin and the second olefin is independently selected from the group consisting of a C₁-C₆ alkyl acrylate and a C₁-C₆ alkyl methacrylate.

In certain embodiments, the polyamine is selected from the group consisting of polyethyleneimine, chitosan, casein, gelatine, bovine serum albumin, and a mixture thereof.

In certain embodiments, the organic acid is selected from the group consisting of malic acid, maleic acid, tartaric acid, citric acid, an amino acid, ethylenediaminetetraacetic acid, HO₂C(CH2)ₘCO₂H, wherein m is whole number selected from 0-10, and mixtures thereof.

In certain embodiments, the polyamine is first olefin is methyl methacrylate, the second olefin is butyl acrylate and the methyl methacrylate and the butyl acrylate are contacted in a weight ratio between 9:1 to 1:1, respectively; and the polyamine and the methyl methacrylate and butyl acrylate are contacted in a weight ratio of total weight of methyl methacrylate and butyl acrylate to polyethyleneimine of about 1 to about 0.5, respectively; or the first olefin is methyl methacrylate and the second olefin is not present and the polyamine and the methyl methacrylate are contacted in a weight ratio of methyl methacrylate to polyamine of about 1 to about 0.5, respectively.

In certain embodiments, the polyamine is polyethyleneimine, the organic acid is citric acid, and the citric acid is contacted with the with the core-shell particle precursors at about 20 mol % of citric acid relative to the polyethyleneimine present in the core-shell particle precursors.

### BRIEF DESCRIPTION OF THE DRAWINGS

The foregoing aspects and many of the attendant advantages of this invention will become more readily appreciated and understood by reference to the following detailed description, when taken in conjunction with the accompanying drawing.

FIG. 1 depicts an exemplary synthetic route of A) PEI/PMMA; and B) PEI/P(MMA-co-BA) amphiphilic core-shell particles.

FIG. 2 depicts a schematic of formation of carbon dots (CDs) on PEI shell using citric acid (CA) to react with the amphiphilic core-shell particles.

FIG. 3 depicts a theoretical mechanism, includes steps 1-4) of the graft polymerization of MMA from a water-soluble polymer containing amino groups.

FIG. 4 depicts FTIR spectra of 25k PEI, MMA and PEI25k/PMMA particles.

FIG. 5 depicts the size and size distribution of PEI25k/PMMA particles.

FIG. 6 depicts A) SEM and TEM (inset) images; and B) Size and size distribution of PEI25/PMMA particles (Count=29).

FIG. 7 depicts conversion between anime and carboxylic acids to form amide structure.

FIG. 8 depicts chemical structures of various organic acids bearing two or three carboxylic acid groups.

FIG. 9 depicts fluorescent spectra of A) PEI25k/PMMA particles and PEI25k/PMMA particles modified with 1 wt/wt of) B) Oxalic acid (OA); C) succinic acid (SA); D) glutaric acid (GA); E) maleic acid (MA); F) L-Malic acid (MaA), G) citric acid (CA); and H) ethylenediaminetetraacetic acid (EDTA), at 1,000 ppm.

FIG. 10 depicts A) bar chart of maximum fluorescent intensities of PEI/PMMA particles modified with different organic acids; and B) Photos of 1% original particles and acid-modified particles under ambient light (top) and 365 nm UV light (bottom).

FIG. 11 depicts a schematic illustration of hydrothermal synthesis of N-CDs using citric acid and PEI.

FIG. 12 depicts SEM images of A-B) critic acid-modified PEI25k/PMMA particles (CA1-PEI25k/PMMA).

FIG. 13 depicts TEM images of A-B) PEI25k/PMMA particles; and C-D) Critic acid-modified PEI25k/PMMA particles (CA1-PEI25k/PMMA).

FIG. 14 depicts TEM images of A-B) CA1-PEI25k/PMMA after centrifugation.

FIG. 15 depicts size and size distribution by DLS of A) original CA1-PEI25k/PMMA particles; B) PEI-CA CDs; and C) Remaining CA1-PEI25k/PMMA particles after centrifugation. The images were taken under ambient light (left) and 365 nm light (right).

FIG. 16 depicts a FTIR spectrum of the CA-PEI CDs.

FIG. 17 depicts A) UV-vis spectrum; and B) Fluorescent spectrum of the CA-PEI CDs.

FIG. 18 depicts size distribution of A) PEI25k/PMMA and CA1-PEI25k/PMMA; and B) Size distribution of PEI750k/PMMA and CA1-PEI750k/PMMA.

FIG. 19 depicts A-C) SEM images; and D) Frequency distribution diagrams of PEI750k/PMMA particles.

FIG. 20 depicts A-C) SEM images; and D) frequency distribution diagrams of CA1-PEI750k/PMMA particles.

FIG. 21 depicts A-B) TEM images of PEI750k/PMMA particles; and C-D) CA1-PEI750k/PMMA particles.

FIG. 22 depicts TEM images of A-B) CA1-PEI750k/PMMA particles after centrifugation.

FIG. 23 depicts fluorescent spectra of A) CA1-PEI25k/PMMA particles and B) CA1-PEI750k/PMMA particles; C) Bar chart of fluorescent intensity of CA1-PEI25k/PMMA particles and CA1-PEI750k/PMMA under excitation of 340 nm to 400 nm; and D) Relative quantum yield of nanodots collected by centrifugation of CA1-PEI25k/PMMA particles and CA1-PEI750k/PMMA particles using quinine sulfate as standard.

FIG. 24 depicts size distribution and zeta-potential of A) PEI750k/PMMA (PEI: MMA=1:3 wt/wt) before and after modified with B) 3.33; C) 10; D) 20; and E) 30 mol % citric acid.

FIG. 25 depicts fluorescent spectra of PEI750k/PMMA modified by A) 3.33; B) 10; C) 20; and D) 30 mol % citric acid; E) Bar chart of fluorescent intensity of the particles under excitation of 340 to 400 nm; and F) Image of the particles under ambient light (top) and 365 nm light excitation (bottom).

FIG. 26 depicts size distribution of PEI750k/PMMA particles of PEI:MMA weight ratio of A) 1:0.5; B)1:1; C)1;2; and D)1:3 before and after modified by 20 mol % CA.

FIG. 27 depicts images of A) PEI750k/PMMA particles; B) Freshly prepared CA20 mol %-PEI750k/PMMA particles with different PEI:MMA weight ratios; and C) CA20 mol %-PEI750k/PMMA particles settled for 24 hours. Particles synthesized with PEI:MMA wt/wt ratios of 1:1, 1:2, 1:3, and 1:4. Images captured under ambient light (top) and 365 UV light (bottom).

FIG. 28 depicts fluorescent spectra of PEI750k/PMMA particles with various shell thicknesses synthesized using A) 1:0.5; B) 1:1; C) 1:2; and D) 1:3 weight ratios of PEI to MMA.

FIG. 29 depicts fluorescent spectra of CA20 mol %-PEI750k/PMMA particles with various shell thicknesses synthesized using A) 1:0.5; B) 1:1; C) 1:2; and D) 1:3 weight ratios of PEI to MMA.

FIG. 30 depicts a bar chart of fluorescence intensity of 20 mol % CA-modified PEI750k/PMMA particles synthetic with 1:0.5, 1:1, 1:2, and 1:3 weight ratio of PEI to MMA.

FIG. 31 depicts size and size distribution of PEI750k/P(MMA-co-BA) particles with different MAA to BA weight ratio before and after modified by 20 mol % CA. MMA:BA weight ratios are A) 10:0; B) 9:1; C) 7:3; and D) 5:5.

FIG. 32 depicts A) Image of PEI750k/P(MMA-co-BA) particles before modification; B) after modification with 20 mol % of CA. The particles were synthesized using PEI:Monomer weight ratios of 1:3, and the MMA:BA weight ratios varied as follows: 10:0, 9:1, 7:3, and 5:5. The images were captured under ambient light (top) and 365 nm UV light (bottom).

FIG. 33 depicts fluorescent spectra of PEI750k/P(MMA-co-BA) particles with different MAA to BA weight ratio. MMA:BA weight ratios are A) 10:0; B) 9:1; C) 7:3; and D) 5:5.

FIG. 34 depicts fluorescent spectra of PEI750k/P(MMA-co-BA) particles with different MAA to BA weight ratio after modification of 20 mol % CA. MMA:BA weight ratios are A) 10:0; B) 9:1; C) 7:3; and D) 5:5.

FIG. 35 depicts a bar chart of fluorescent intensity of 20 mol % CA modified-PEI750k/P(MMAco-BA) particles with various MAA to BA ratio (wt/wt).

FIG. 36 depicts SEM images of A-B) PEI750k/P(MMA-co-BA) particles; and C-D) CA20 mol %-PEI750k/P(MMA-co-BA) particles.

FIG. 37 depicts images of A-B) PEI750k/P(MMA-co-BA) particles; and C-D) CA20 mol %-PEI750k/P(MMA-co-BA) particles.

FIG. 38 depicts thermogravimetric analysis (TGA) curves and derivative thermogravimetry (DTG) curve of CA20 mol %-PEI750k/P(MMA-co-BA) particles.

FIG. 39 depicts fluorescent spectra of CA20 mol %-PEI750k/P(MMA-co-BA) particles in aqueous.

FIG. 40 depicts fluorescent spectra of CA20 mol %-PEI750k/P(MMA-co-BA) particles in solid state.

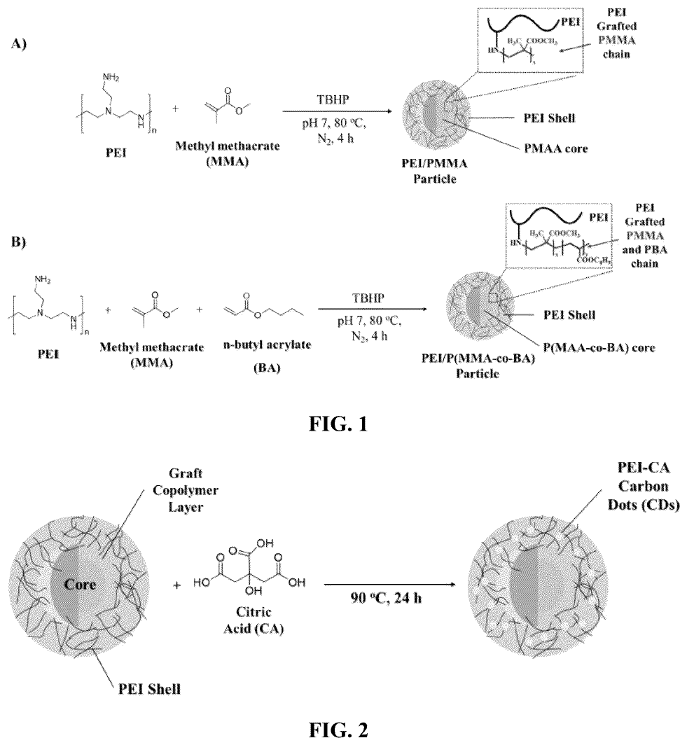

### DETAILED DESCRIPTION

### Definitions

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present disclosure and claims, unless the context requires otherwise, the word “include” or variations such as “includes” or “including”, will be understood to imply the inclusion of a stated integer or group of integers, but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

As used herein, a “polymeric compound” (or “polymer”) refers to a molecule including a plurality of one or more repeating units connected by covalent chemical bonds. A polymeric compound can be represented by General Formula I:

$$* — {( — {( Ma )}_{x} — {( Mb )}_{y} — )}_{z} * \qquad General Formula I$$

wherein each Ma and Mb is a repeating unit or monomer. The polymeric compound can have only one type of repeating unit as well as two or more types of different repeating units. When a polymeric compound has only one type of repeating unit, it can be referred to as a homopolymer. When a polymeric compound has two or more types of different repeating units, the term “copolymer” or “copolymeric compound” can be used instead. For example, a copolymeric compound can include repeating units where Ma and Mb represent two different repeating units. Unless specified otherwise, the assembly of the repeating units in the copolymer can be head-to-tail, head-to-head, or tail-to-tail. In addition, unless specified otherwise, the copolymer can be a random copolymer, an alternating copolymer, a block copolymer, or a graft copolymer. For example, General Formula I can be used to represent a copolymer of Ma and Mb having x mole fraction of Ma and y mole fraction of Mb in the copolymer, where the manner in which comonomers Ma and Mb is repeated can be alternating, random, regiorandom, regioregular, or in blocks and grafts, with up to z comonomers present. In addition to its composition, a polymeric compound can be further characterized by its degree of polymerization (n) and molar mass (e.g., number average molecular weight (Mn) and/or weight average molecular weight (Mw) depending on the measuring technique(s)). The polymers described herein can exist in numerous stereochemical configurations, such as isotactic, syndiotactic, atactic, or a combination thereof.

The term “alkyl” is art-recognized, and includes saturated aliphatic groups, including straight-chain alkyl groups, branched-chain alkyl groups, cycloalkyl (alicyclic) groups, alkyl substituted cycloalkyl groups, and cycloalkyl substituted alkyl groups. In certain embodiments, a straight chain or branched chain alkyl has about 30 or fewer carbon atoms in its backbone (e.g., C₁-C₃₀ for straight chain, C₃-C₃₀ for branched chain), and alternatively, about 20 or fewer. Likewise, cycloalkyls have from about 3 to about 10 carbon atoms in their ring structure, and alternatively about 5, 6 or 7 carbons in the ring structure.

Provided herein are fluorescent core-shell particles comprising a core, a first shell disposed on a surface of the core, and a second shell disposed on a surface of the first shell, wherein the core comprises a first polymer selected from a group consisting of a poly(alkyl acrylate), a poly(alkyl methacrylate), a poly(alkyl acrylamide), a polyacrylonitrile, a polyacetate, and copolymers thereof, the first shell comprises a polyamine and a second polymer selected from a group consisting of a poly(alkyl acrylate), a poly(alkyl methacrylate), a poly(alkyl acrylamide), a polyacrylonitrile, a polyacetate, and copolymers thereof; and the second shell comprises a second polyamine and a plurality of carbon dots, wherein at least a portion of the first polyamine in the first shell is grafted to the second polymer.

The first polymer and the second polymer can be the same or different. Each of the first polymer and the second polymer can independently be selected from a poly(C₁-C₆ alkyl acrylate), a poly(C₁-C₅ alkyl acrylate), a poly(C₁-C₄ alkyl acrylate), a poly(C₁-C₃ alkyl acrylate), a poly(C₁-C₂ alkyl acrylate), a poly(C₁-C₆ alkyl methacrylate), a poly(C₁-C₅ alkyl methacrylate), a poly(C₁-C₄ alkyl methacrylate), a poly(C₁-C₃ alkyl methacrylate), a poly(C₁-C₂ alkyl methacrylate), a poly(C₂-C₆ alkyl methacrylate), a poly(C₃-C₆ alkyl methacrylate), a poly(C₄-C₆ alkyl methacrylate), a poly(C₅-C₆ alkyl methacrylate), a poly(C₂-C₆ alkyl methacrylate), a poly(C₃-C₅ alkyl methacrylate), a poly(C₁-C₆ alkyl acrylamide), a poly(C₁-C₅ alkyl acrylamide), a poly(C₁-C₄ alkyl acrylamide), a poly(C₁-C₃ alkyl acrylamide), a poly(C₁-C₂ alkyl acrylamide), and copolymers thereof, and mixtures thereof. Exemplary first polymer and second polymers useful in the fluorescent core-shell particles described herein include, but are not limited to a poly(methyl acrylate), a poly(ethyl acrylate), a poly(propyl acrylate), a poly(n-butyl acrylate), a poly(isobutyl acrylate), a poly(tert-butyl acrylate), a poly(pentyl acrylate), a poly(hexyl acrylate), a poly(methyl methacrylate), a poly(ethyl methacrylate), a poly(propyl methacrylate), a poly(n-butyl methacrylate), a poly(isobutyl methacrylate), a poly(tert-butyl methacrylate), a poly(pentyl methacrylate), a poly(hexyl methacrylate), poly(acrylamide), poly(N-methyl acrylamide), poly(N-ethyl acrylamide), poly(N-isoproplyacrylamide) and copolymers thereof. In certain embodiments, the first polymer and the second polymer are to a poly(methyl acrylate) or a poly(methyl methacrylate-co-butyl acrylate). The weight average molecular weight of the first and second polymer can independently be from 1,000 to 500,000 kDa.

Each of the first polyamine and the second polyamine can independently be selected from the group consisting of polyethyleneimine, chitosan, casein, gelatine, bovine serum albumin, and a mixture thereof.

The first polyamine present in the first shell and the second polyamine present in the second shell can be the same or different. In certain embodiments, each of the first polyamine present in the first shell and the second polyamine present in the second shell is a branched polyethyleneimine, a linear polyethyleneimine, or a mixture thereof. In instances in which the first polyamine and the second polyamine is a polyethyleneimine, each polyethyleneimine can independently have a weight average molecular weight of 1,000-1,000,000 kDa, 1,000-900,000 kDa, 1,000-800,000 kDa, 1,000-750,000 kDa, 10,000-750,000 kDa, 15,000-750,000 kDa, 20,000-750,000 kDa, 25,000-750,000 kDa, 600,000-900,000 kDa, 650,000-850,000 kDa, 700,000-800,000 kDa, 725,000-775,000 kDa, 5,000-45,000 kDa, 10,000-40,000 kDa, 15,000-35,000 kDa, 20,000-30,000 kDa, or 22,500-27,500 kDa. In certain embodiments, the first polyamine and the second polyamine is polyethyleneimine having a weight average molecular weight of about 25,000 kDa or about 750,000 kDa.

The optical properties of the fluorescent core-shell particles described herein can be optimized by appropriate selection of the reagents and/or reaction conditions used for their preparation.

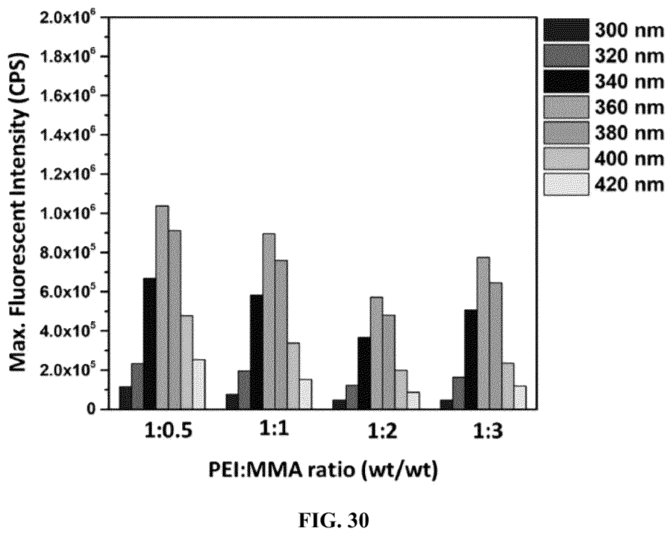

For example, as shown in FIG. 30, the fluorescence intensity of fluorescent core-shell particles can be optimized when the fluorescent core-shell particles comprise polyethyleneimine and poly(methyl methacrylate) in a weight ratio of 1:0.5 to 1:3, 1:0.5 to 1:2, 1:0.5 to 1:1, or about 1 to about 0.5, respectively.

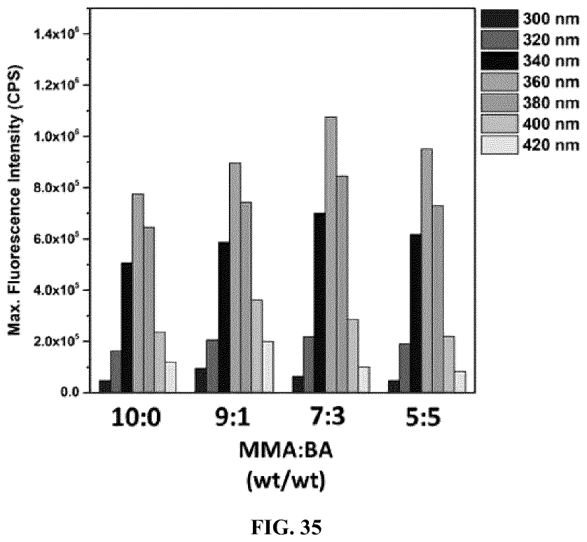

In another example, FIG. 35 demonstrates that in instances in which the first polymer and the second polymer are a poly(methyl methacrylate-co-butyl acrylate), the maximum fluorescence intensity of fluorescent core-shell particles comprising the same can be realized when the weight ratio of methyl methacrylate repeating units to butyl acrylate repeating units is between 1:1 to 9:1, 9:1 to 3:2 to 9:1, 7:3 to 9:1, 4:1 to 9:1, 1:1 to 4:1, 1:1 to 7:3, or 1:1 to 3:2, respectively. In certain embodiments, the first polymer and the second polymer are a poly(methyl methacrylate-co-butyl acrylate) comprising a weight ratio of methyl methacrylate repeating units to butyl acrylate repeating units is about 7 to about 3, respectively.

In other examples, the weight ratio of the total weight of the first polyamine and the second polyamine to the total weight of the first polymer and the second polymer can be 1:1 to 9:1, 9:1 to 3:2 to 9:1, 7:3 to 9:1, 4:1 to 9:1, 1:1 to 4:1, 1:1 to 7:3, 1:1 to 3:2, 1:0.5 to 1:3, 1:0.5 to 1:2, 1:0.5 to 1:1, 1:1 to 1:3, 1:2 to 1:3 or 1:1 to 1:2, respectively.

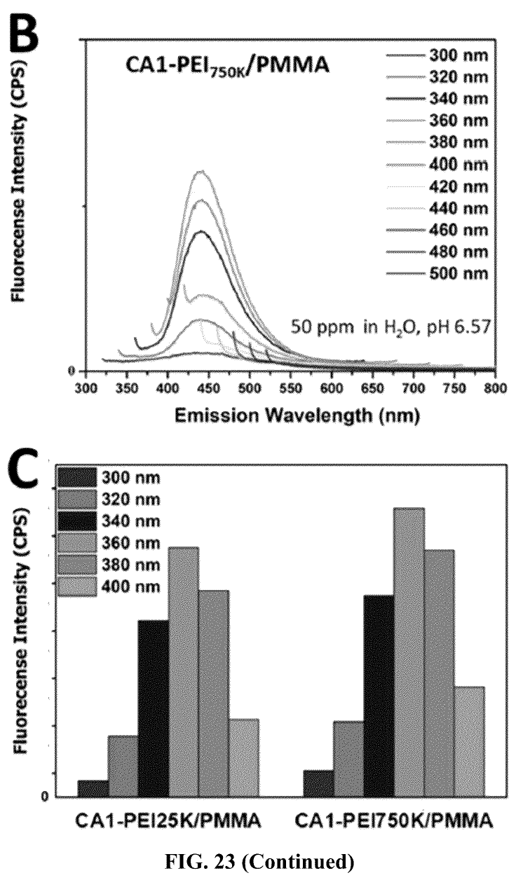

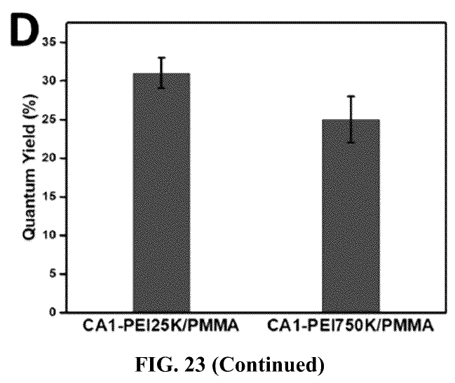

As demonstrated in FIG. 23C, fluorescent core-shell particles comprising polyethyleneimine in the first shell and the second shell have a weight average molecular weight of about 750,000 kDa exhibit improved fluorescent intensity than fluorescent core-shell particle comprising polyethyleneimine in the first shell and the second shell have a weight average molecular weight of about 25,000 kDa.

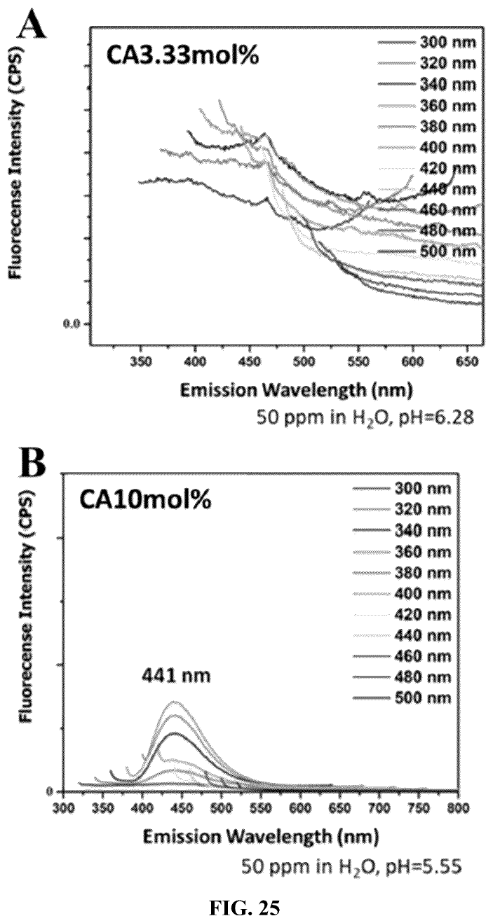

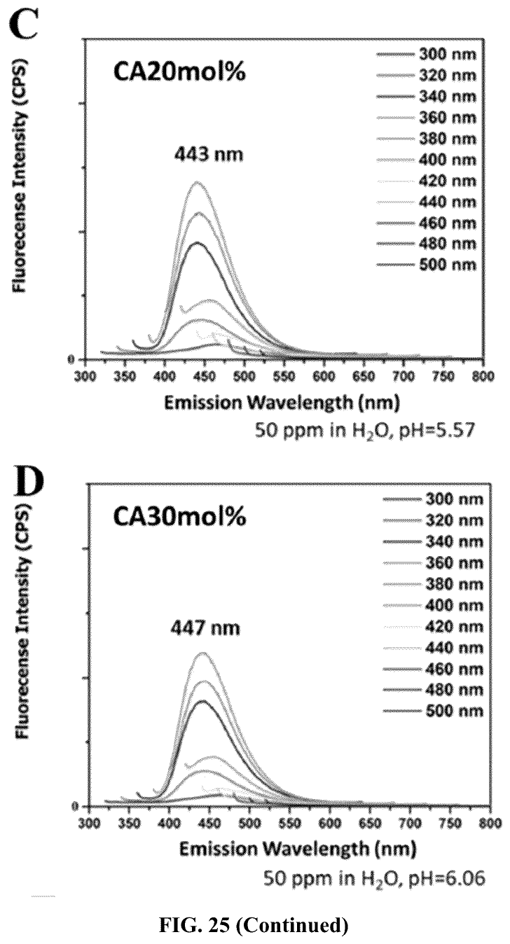

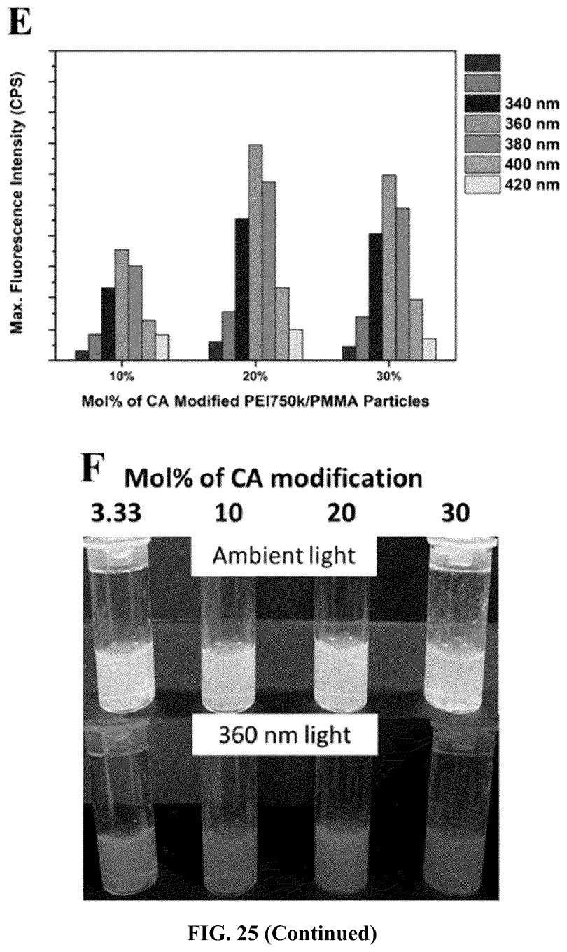

FIG. 25E demonstrates that the fluorescent intensity of fluorescent core-shell particles prepared by hydrothermal reaction of citric acid at concentration between 10-30 mol % of citric acid relative to the polyethyleneimine present in the fluorescent core-shell particle precursors is optimal with a maximum fluorescence intensity observed at about 20 mol % of citric acid relative to the polyethyleneimine present in the fluorescent core-shell particle precursors.

The plurality of carbon dots can comprise an amorphous framework comprising both crystalline and non-crystalline domains comprising graphite, fullerenes, graphene, carbon black, carbon nanofibers, carbon nanotubes, single-walled carbon nanotubes, quantum dots, and mixtures thereof that are optionally functionalized with one or more heteroatoms selected from oxygen and nitrogen. The plurality of carbon dots can have an average diameter ranging from 2-50 nm, 2-45 nm, 2-40 nm, 5-40 nm, 10-40 nm, 14 to 40 nm, 14 to 30 nm, 14 to 25 nm, or 14 to 20 nm. In certain embodiments, the plurality of carbon dots can have an average diameter of about 14 nm to about 40 nm. As discussed in greater detail herein, the plurality of carbon dots can readily be prepared by hydrothermal treatment of an organic acid in the presence of core-shell particle precursors, which results in the formation and incorporation of the plurality of carbon dots within the second shell of the thus formed fluorescent core-shell particles.

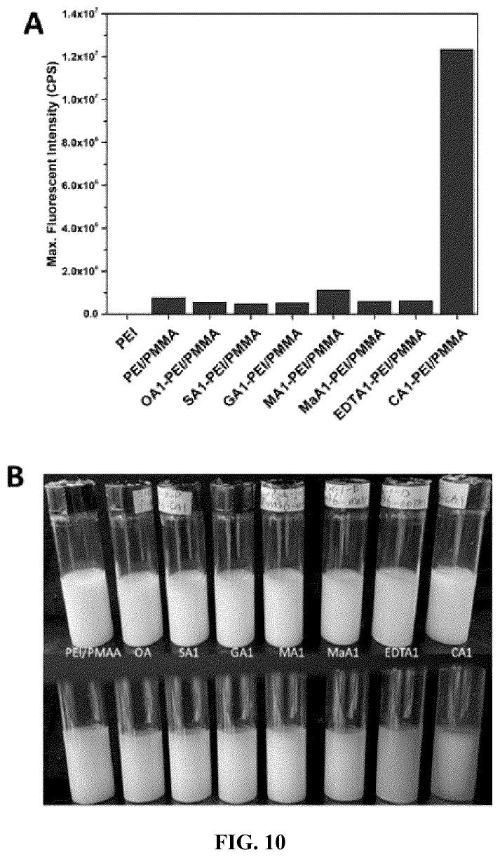

The organic acid used in the hydrothermal treatment reaction to prepare the plurality of carbon dots is not particularly limited and can be organic acid that can be converted to carbon dots by hydrothermal treatment known to those of skill in the art. In certain embodiments, the organic acid is selected from the group consisting of malic acid, maleic acid, tartaric acid, citric acid, an amino acid, ethylenediaminetetraacetic acid, HO₂C(CH₂)ₘCO₂H, wherein m is whole number selected from 0-10, 0-9, 0-8, 0-6, 0-5, 0-4, 0-3, or 0-2, and mixtures thereof. Exemplary organic acids useful for preparing the fluorescent core-shell particles described herein include, but are not limited to, oxalic acid, malic acid, citric acid, ethylenediaminetetraacetic acid, succinic acid, glutaric acid, maleic acid, and mixtures thereof. As demonstrated in FIG. 10A, when citric acid is used to form the carbon dots, the fluorescent intensity of the resulting fluorescent core-shell particles is the highest of all of the organic acids evaluated.

The average particle size of the fluorescent core-shell particles can range from 100-1000 nm or 200-500 nm.

The fluorescent core-shell particles described herein can fluoresce at a maximum intensity at a wavelength between 400-550 nm, 400-525 nm, 400-500 nm, 400-475 nm, 400-475, 425-475 nm, or 440-460 nm when they are irradiated with light having a wavelength between 300-500 nm, 300-450 nm, 300-400 nm, 320-390 nm, or 340-380 nm.

The present disclosure also provides a coated inorganic particle comprising the fluorescent core-shell particles described herein coated on at least one surface of an inorganic particle. It has been found that surfaces covered with inorganic particles coated with the fluorescent core-shell particles described herein exhibit sub-ambient daytime radiative cooling (SDRC) resulting in a reduction in the surface temperature by up to 1-4° C. in direct sunlight. In certain embodiments, the fluorescent core-shell particles are coated in a resin or a polymer coating on the surface of the inorganic particle. In certain embodiments, the inorganic particle is selected from the group consisting of SiO₂, TiO₂, CaCO₃, silicon carbide (SiC), ZnO, Al₂O₃, and Zn. In certain embodiments, the inorganic particle is a hollow glass particle, such as a hollow glass microsphere. The polymer or resin can be one or more polymers selected from the group consisting of polystyrene, polyacrylate, polyalkylacrylate, polymethacrylate, polyalkylmethacrylate, polycarbonate, poly(acryclic acid), poly(methacrylic acid), and mixtures thereof, and copolymers thereof.

Also provided herein is a method of preparing the fluorescent core-shell particles described herein, the method comprising: contacting a first olefin selected from an alkyl acrylate, an alkyl methacrylate, an acrylamide, an alkyl acrylamide, vinyl nitrile, and a vinylacetate, optionally a second olefin selected from an alkyl acrylate, an alkyl methacrylate, an acrylamide, an alkyl acrylamide, vinyl nitrile, and a vinylacetate, a polyamine, and a radical initiator thereby forming core-shell particle precursors comprising: a first shell disposed on a surface of a core, and a second shell disposed on a surface of the first shell, wherein the core comprises a first polymer selected from a group consisting of a poly(alkyl acrylate), a poly(alkyl methacrylate), a polyacrylamide, a poly(alkyl acrylamide), a polyacrylonitrile, a polyacetate, and copolymers thereof, the first shell comprises the polyamine and a second polymer selected from a group consisting of a poly(alkyl acrylate), a poly(alkyl methacrylate), a polyacrylamide, a poly(alkyl acrylamide), a polyacrylonitrile, a polyacetate, and copolymers thereof, and the second shell comprises the polyamine, wherein at least a portion of the polyamine in the first shell is grafted to the second polymer; contacting the core-shell particle precursors with an organic acid thereby forming a reaction mixture; and subjecting the reaction mixture to hydrothermal conditions resulting in the formation of the plurality of carbon dots in the second shell and thereby forming the fluorescent core-shell particles in which the first polyamine and the second polyamine are the same.

The first olefin and the optional second olefin (if present) can independently be selected from the group consisting of a C₁-C₆ alkyl acrylate, a C₁-C₅ alkyl acrylate, a C₁-C₄ alkyl acrylate, a C₁-C₃ alkyl acrylate, C₅-C₆ alkyl acrylate, a C₁-C₂ alkyl acrylate, C₂-C₆ alkyl acrylate, C₃-C₆ alkyl acrylate, C₄-C₆ alkyl acrylate, a C₁-C₆ alkyl methacrylate, a C₁-C₅ alkyl methacrylate, a C₁-C₄ alkyl methacrylate, a C₁-C₃ alkyl methacrylate, a C₁-C₂ alkyl methacrylate, a C₂-C₆ alkyl methacrylate, a C₃-C₆ alkyl methacrylate, a C₄-C₆ alkyl methacrylate, a C₅-C₆ alkyl methacrylate, a C₂-C₅ alkyl methacrylate, a C₃-C₆ alkyl methacrylate, a C₃-C₅ alkyl methacrylate, N—C₁-C₆ alkyl acrylamide, N—C₁-C₅ alkyl acrylamide, N—C₁-C₄ alkyl acrylamide, N—C₁-C₃ alkyl acrylamide, N—C₁-C₂ alkyl acrylamide, and combinations thereof. Compounds useful as the first olefin and the optional second olefin in the methods described herein include, but are not limited to, methyl acrylate, ethyl acrylate, isopropyl acrylate, n-propyl acrylate, n-butyl acrylate, isobutyl acrylate, t-butyl acrylate, pentyl acrylate, hexyl acrylate, methyl methacrylate, ethyl methacrylate, isopropyl methacrylate, n-propyl methacrylate, n-butyl methacrylate, isobutyl methacrylate, t-butyl methacrylate, pentyl methacrylate, hexyl methacrylate, acrylamide, N-methyl acrylamide, N-ethyl acrylamide, N-n-propyl acrylamide, N-methyl acrylamide, N-isopropyl acrylamide, N-n-butyl acrylamide, N-t-butyl acrylamide, and combinations thereof.

All radical initiators known in the art as useful for initiating the radical polymerization of acrylate and/or methacrylate olefins are contemplated by the present disclosure. In certain embodiments, the radical initiator comprises ultraviolet radiation, a radical initiator, heat, or a combination thereof. The radical initiator can be an organic peroxide, inorganic peroxide, azoalkanes, or a metal. Exemplary radical initiator include, but are not limited to, hydrogen peroxide, tert-butyl hydroperoxide, di-tert-butyl peroxide, dicumyl peroxide, t-butylcumyl peroxide, α,α-bis(tert-butylperoxy)diisopropyl benzene, 2,5 dimethyl 2,5-di(t-butylperoxy)hexane, 1,1-di(t-butylperoxy)-3,3,5-trimethyl cyclohexane, benzoyl peroxide, lauroyl peroxide, dilauroyl peroxide, 2,5-dimethyl-2,5-di(tert-butylperoxy)hexyne-3, azobisisobutyronitrile (AIBN), 1,1′-azobis(cyclohexanecarbonitrile (ABCN), potassium persulfate, ammonium persulfate, iron sulfate, iron chloride and combinations thereof. In certain embodiments, the radical initiator comprises tert-butyl hydroperoxide. The radical initiator can be used at 0.05-10 mol %, 0.05-7.5 mol %, 0.05-5 mol %, 0.1-5 mol %, or 0.2-4 mol % relative to the first olefin and optionally the second olefin.

The first olefin, optionally the second olefin, and the polyethyleneimine can be contacted in weight ratio of polyethyleneimine to total weight of first olefin and optionally the second olefin of 1 to 0.5-5, 1 to 0.5-4, 1 to 0.5-3, 1 to 0.5-2, or 1 to 0.5-1, respectively. In certain embodiments, the first olefin, optionally the second olefin, and the polyethyleneimine are contacted in weight ratio of polyethyleneimine to total weight of first olefin and optionally the second olefin of about 1 to about 4, respectively.

In instances in which the first olefin is methyl methacrylate and the second olefin is butyl acrylate, the methyl methacrylate and the butyl acrylate are contacted in a weight ratio of 1:1 to 9:1, 9:1 to 3:2 to 9:1, 7:3 to 9:1, 4:1 to 9:1, 1:1 to 4:1, 1:1 to 7:3, or 1:1 to 3:2, respectively. In certain embodiments, methyl methacrylate and the butyl acrylate are contacted in a weight ratio of about 7 to about 3, respectively.

The step of contacting the first olefin optionally the second olefin a polyethyleneimine, and the radical initiator can be conducted neat or in a solvent. Suitable solvents include, but are not limited to water, alcohols, and mixtures thereof.

The step of contacting the first olefin, optionally the second olefin, the polyethyleneimine, and the radical initiator can be conducted at 20-100° C., 30-100° C., 40-100° C., 50-100° C., 60-100° C., 60-90° C., or 70-90° C. In certain embodiments, the step of contacting the first olefin, optionally the second olefin, the polyethyleneimine, and the radical initiator is conducted at about 80° C.

The organic acid is not particularly limited. Any organic acid that can be converted to carbon dots by hydrothermal treatment is contemplated by the present disclosure. In certain embodiments, the organic acid is selected from the group consisting of malic acid, maleic acid, tartaric acid, citric acid, an amino acid, ethylenediaminetetraacetic acid, HO₂C(CH2)ₘCO₂H, wherein m is whole number selected from 0-10, 0-9, 0-8, 0-6, 0-5, 0-4, 0-3, or 0-2. Exemplary organic acids include, but are not limited to, oxalic acid, malic acid, citric acid, ethylenediaminetetraacetic acid, succinic acid, glutaric acid, maleic acid, and mixtures thereof.

The organic acid can be contacted with the core-shell particle precursors at a concentration of 1-50 mol %, 5-50 mol %, 10-50 mol %, 10-40 mol %, 10-30 mol %, 15-25 mol %, 10-20 mol %, or 20-30 mol % of organic acid relative to the polyethyleneimine present in the fluorescent core-shell particle precursors. In certain embodiments, the organic acid can be contacted with the core-shell particle precursors at a concentration of about 20 mol % of organic acid relative to the polyethyleneimine present in the core-shell particle precursors.

The step of contacting the organic acid and the core-shell particle precursors can be conducted in a reaction solvent in which the organic acid is at least partially soluble. In certain embodiments, the step of contacting the organic acid and the core-shell particle precursors is conducted in a reaction solvent selected from the group consisting of an alcohol, water, and mixtures thereof. In certain embodiments, the step of contacting the organic acid and the core-shell particle precursors is conducted in water.

The step of contacting the organic acid and the core-shell particle precursors can be conducted at a temperature between 80-250° C., 80-200° C., 80-150° C., 80-100° C., or 80-95° C. In certain embodiments, the step of contacting the organic acid and the core-shell particle precursors is conducted at a temperature of about 90° C. In certain embodiments, the step of contacting the organic acid and the core-shell particle precursors is conducted in a microwave or in a closed vessel under autogenic pressure.

Without wishing to be bound by theory, the Inventors hypothesize that the hydrothermal reaction of the organic acid is catalyzed by the core-shell particle precursors, which act as nanoreactors that, e.g., significantly increase the local concentration of the amine functional group within the second shell comprising the polyethyleneimine and/or acting as a template to stabilize and encapsulate the resulting carbon dots, thereby reducing the temperature that the hydrothermal reaction of the organic acid is conducted.

The methods described herein can also be extended to a method for preparing carbon dots. The Inventors have discovered that the plurality of the carbon dots formed in the core-shell particle can be extracted and isolated as discrete carbon dots by subjecting the core-shell particle to centrifugation (e.g., ultra-centrifugation). In certain embodiments, the method for preparing carbon dots comprises: contacting a first olefin selected from an alkyl acrylate, an alkyl methacrylate, an acrylamide, an alkyl acrylamide, vinyl nitrile, and a vinylacetate, optionally a second olefin selected from an alkyl acrylate, an alkyl methacrylate, an acrylamide, an alkyl acrylamide, vinyl nitrile, and a vinylacetate, a polyethyleneimine, and a radical initiator thereby forming core-shell particle precursors comprising: a first shell disposed on a surface of a core, and a second shell disposed on a surface of the first shell, wherein the core comprises a first polymer selected from a group consisting of a poly(alkyl acrylate), a poly(alkyl methacrylate), a polyacrylamide, a poly(alkyl acrylamide), a polyacrylonitrile, a polyacetate, and copolymers thereof; the first shell comprises polyethyleneimine grafted polymer selected from a group consisting of a poly(alkyl acrylate), a poly(alkyl methacrylate), a polyacrylamide, a poly(alkyl acrylamide), a polyacrylonitrile, a polyacetate, and copolymers thereof, and the second shell comprises polyethyleneimine, wherein at least a portion of the polyethyleneimine in the first shell is grafted to the second polymer; contacting the core-shell particle precursors with an organic acid thereby forming a reaction mixture; subjecting the reaction mixture to hydrothermal conditions resulting in the formation of the plurality of carbon dots in the second shell and thereby forming the fluorescent core-shell particles; combining the fluorescent core-shell particles with a solvent thereby forming a mixture; subjecting the mixture to centrifugation resulting in the separation of at least a portion of the plurality of carbon dots from the core-shell particles thereby forming discrete carbon dots; and collecting the discrete carbon dots.

The present disclosure also provides a method comprising: providing the fluorescent core-shell particles described herein; irradiating the fluorescent core-shell particles with UV light; and optionally detecting fluorescent emission of the fluorescent core-shell particles. In certain embodiments, the fluorescent core-shell particles are irradiated with light having a wavelength between 300-500 nm, 300-450 nm, 300-400 nm, 320-390 nm, or 340-380 nm. In certain embodiments, the fluorescent core-shell particles fluoresce at a maximum intensity at a wavelength between 400-550 nm, 400-525 nm, 400-500 nm, 400-475 nm, 400-475, 425-475 nm, or 440-460 nm.

Surface Modification of PEI25k/PMMA Particles with Different Types of Organic Acids

The inclusion of organic acid into the PEI molecules can occur via interact electrostatically between the positively charged PEI segments and negatively charged organic acid. The effect of different organic acids with varying crosslinking abilities on the transformation of PEI-based core-shell particles into fluorescent particles was studied by combining the core-shell particles with the organic acid in an aqueous medium at 90° C. for 24 hours. Initially, the PEI25k/PMMA particles (PEI25k:MMA=1:3.6 wt/wt) were selected as the model particles for this investigation.

### Synthesis and Characterization of PEI25k/PMMA Particles

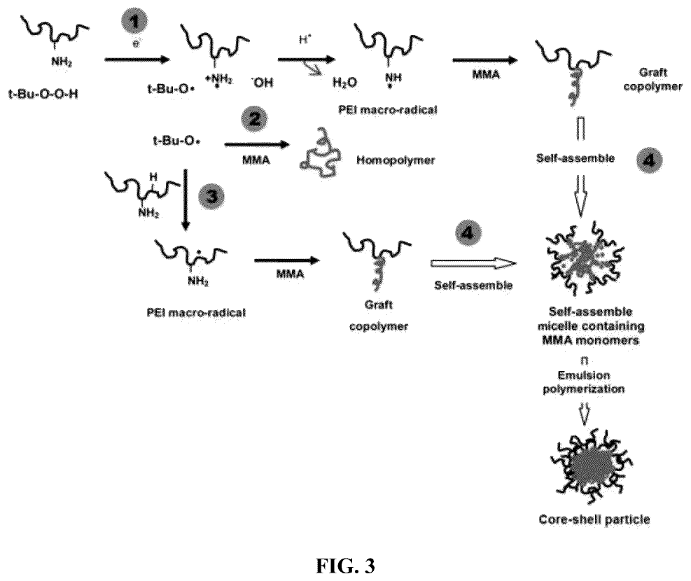

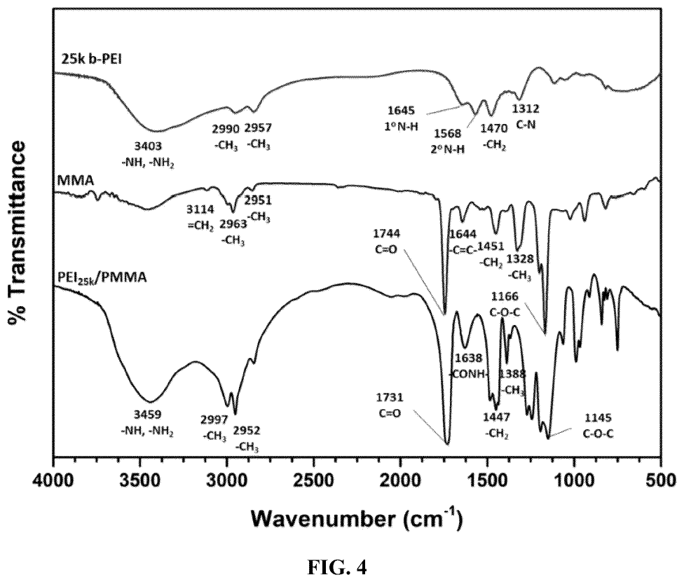

The synthesis of PEI25k/PMMA core-shell particles was achieved using a surfactant-free emulsion copolymerization method. The detailed procedure for the polymerization is described in detail below. The polymerization mechanism is illustrated in FIG. 3, based on the aqueous-phase redox reaction between TBHP and amine functional groups of a water-soluble polymer. The initiation step occurs when water-soluble polymers containing amine groups interact with a small amount of TBHP in the aqueous medium, leading to the generation of free radicals on the amine nitrogen atoms. These radicals serve as initiators for the graft polymerization of the hydrophobic monomer. The tert-butoxy radicals generated during the initiation step can either initiate the homopolymerization of the monomer or abstract hydrogen from the backbone of the amine-containing polymer. The resulting amphiphilic macro-radicals have the ability to self-assemble, forming polymeric micelle-like micro-domains. These micro-domains act as loci for the subsequent polymerization of the monomer, resembling an emulsion polymerization process.

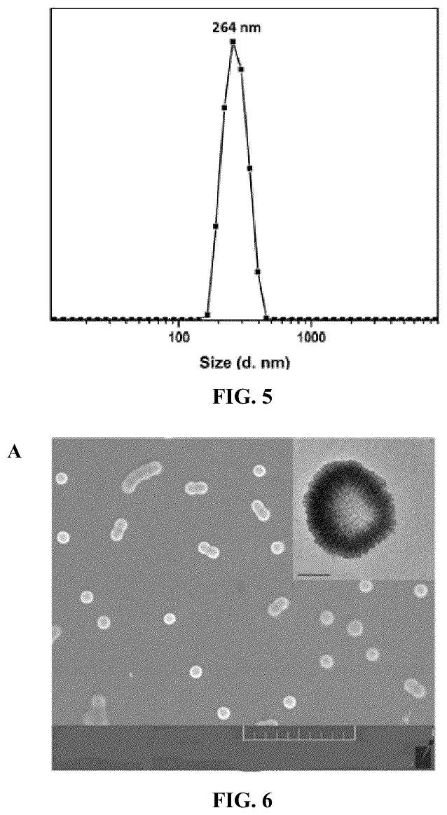

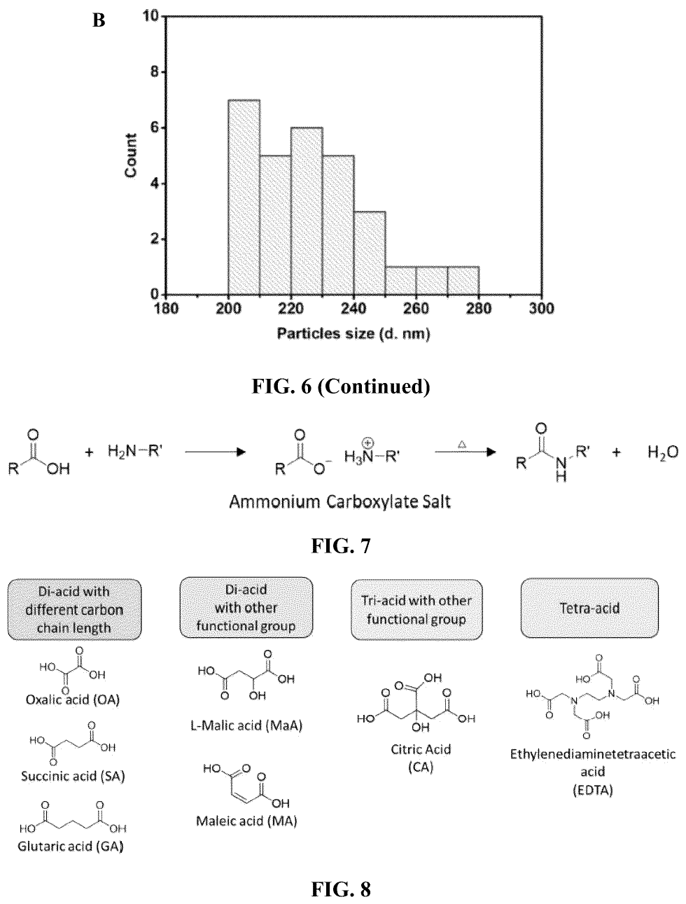

The particle sizes and distributions of the preformed PEI25k/PMMA particles, were determined with the dynamic light scattering (DLS). FIG. 6 shows the average particles size of the PEI25k/PMMA particles is 264 nm in diameter with narrow distribution (PDI=0.04). The surface charge of the particles is +49.2 (±0.2) mV, indicating the particles surface is mainly constructed by the amine rich PEI. In FIG. 6, the TEM images revealed that the PEI25k/PMMA particles exhibited an approximate diameter of 274 nm and possessed a two-layered core-shell structure. The surface of the particles appeared dark, indicating the presence of PEI, while the central region appeared white, indicating the presence of PMMA polymer. It's worth noting that the boundary between the core and shell was not clearly distinguishable, likely due to the mixing or blending of PEI and PMMA polymer, resulting in a gradual transition between the core and shell. FIG. 6 depicts SEM images of the PEI25k/PMMA particles, which exhibit a spherical shape with diameters ranging from 200 to 280 nm. The SEM images also reveal a distinct core-shell structure, where the grey color represents the PEI shell, and the white color represents the PMMA core.

Modification of PEI25k/PMMA Particles with Organic Acid

When primary amines of polyethyleneimine (PEI) react with molecules that contain more than two carboxylic acid groups, a crosslinking process takes place, leading to the formation of an ammonium carboxylate salt and a three-dimensional network. Since the reaction was conducted at 90° C. for 24 hours, it is expected that the interconnection of PEI chains can also occur through the newly formed amide bonds (FIG. 7). Therefore, the crosslinking of PEI with molecules containing multiple carboxylic acid groups not only yields an ammonium carboxylate salt, but also gives rise to a crosslinked network through amide linkages. Based on the theory of crosslink enhanced mission (CEE) effect, the degree of crosslinking of PEI will increase the immobilization of the polymer matrix, thus the photoluminescent (PL). Therefore, various crosslinker, shown in FIG. 8, bearing two to three carboxylic acid groups were applied to undergo amidation with the PEI of the PEI25k/PMMA particles to enhance the particles' PL property.

### Photoluminescent Properties of Modified PEI25k/PMMA Particles

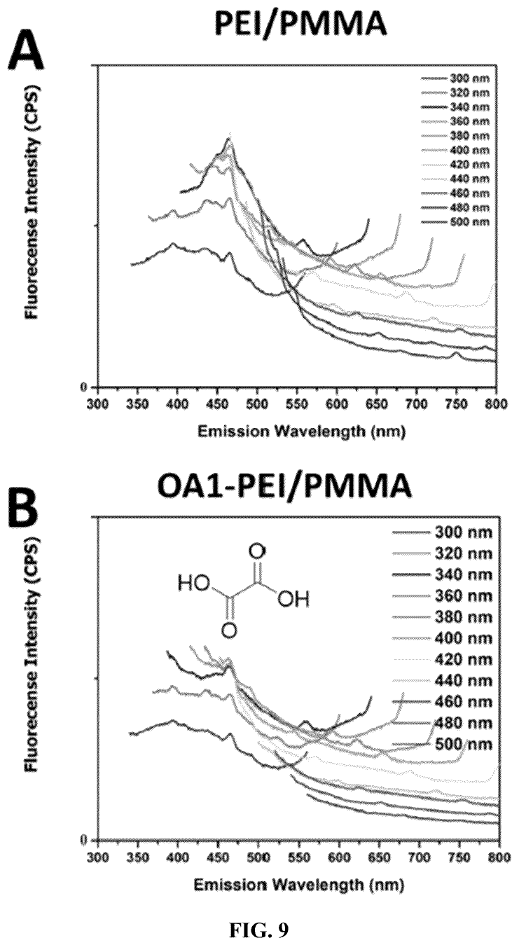

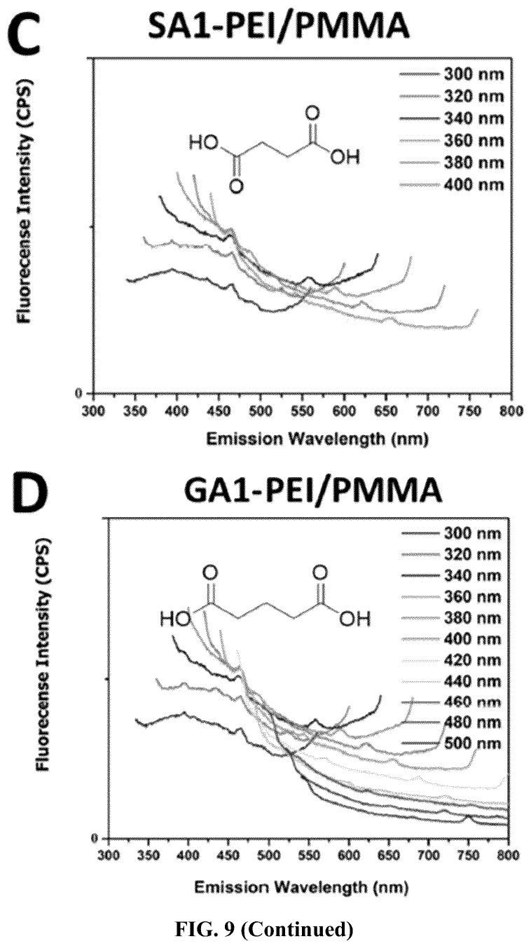

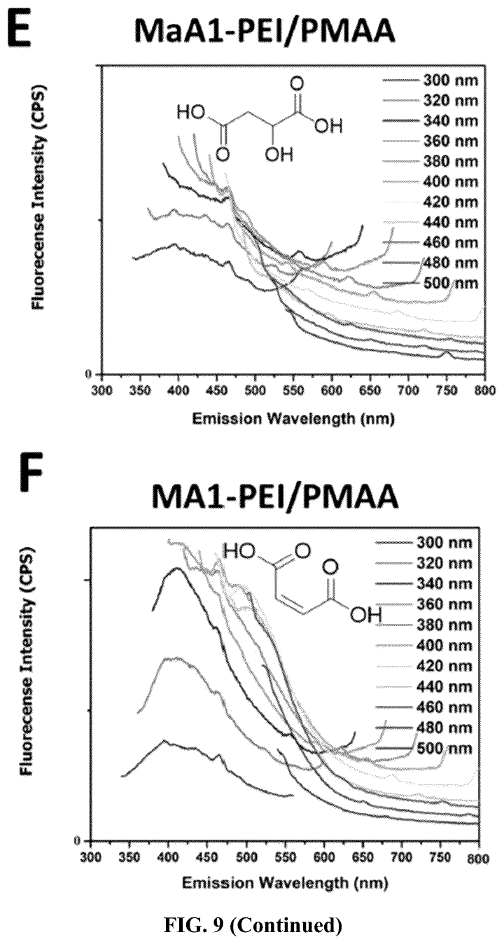

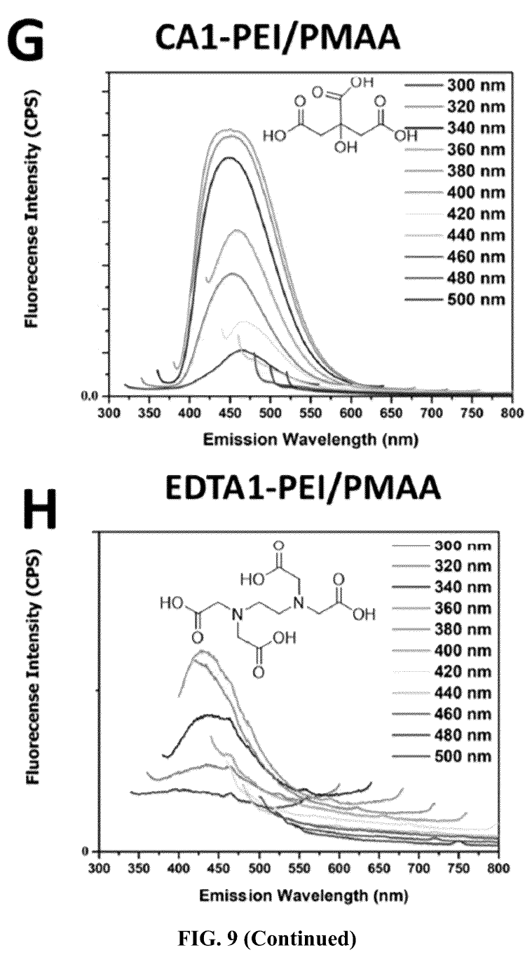

FIG. 9 illustrates the fluorescent intensities of the particles, which were modified with different organic acids. The measurements were taken across a range of wavelengths, specifically between 300 and 500 nm. The original PEI25k/PMMA particles exhibited weak fluorescence, with excitation independent fluorescence property when excited by UV light ranging from 300 to 400 nm (FIG. 9A). The excitation maximum was observed at 340 nm, with a corresponding emission maximum at 467 nm. After being modified with oxalic acid (OA), succinic acid (SA), and glutaric acid (GA), the fluorescent properties of the particles showed little changes (FIG. 9B-D). This suggests that the crosslinking between diacid with varying carbon chain length between the two carboxylic acid groups has no significant impact on the fluorescence property. In the case of L-malic acid (MaA) modification, the fluorescent property of the particles were also unaltered (FIG. 9E), suggesting that the presence of a hydroxy group (—OH) in malic acid MaA does not affect the particles' fluorescence. When the particles were modified with maleic acid (MA) which contains a double bond between the two carboxylic acid groups, the fluorescent intensity was enhanced (FIG. 9F). Notably, the emission maximum shifted to 425 nm when excited with 360 nm light. This indicates that the presence of a C═C bond in the diacid molecule can enhance the fluorescent intensity but cause a blue shift in the particles' emission. This effect may attribute to the presence of conjugated C═C bond in the MA molecule which creates a delocalized 71 electrons. The conjugation increases the probability of electronic transitions and promotes more efficient radiative decay processes.

Upon modification with citric acid (CA) which contains three carboxylic acid groups, the resulting particles exhibited a significant increase in fluorescent intensity (FIG. 9G). The excitation maximum was observed at 360 nm, with a corresponding emission maximum at 467 nm. These citric acid-modified particles also displayed excitation-independent fluorescent properties within the 320-400 nm range but became excitation-dependent when excited with light between 420 and 500 nm. Further modification of the particles with EDTA, which contains four carboxylic acid groups, did not show enhancement of the fluorescent intensity. The emission maximum was also blue shifted (FIG. 9G). Therefore, the organic acid molecule containing three carboxylic acid group is most appropriate in crosslinking leading to an enhancement in fluorescent intensity. The bar chart shown in FIG. 10A provides a comparison of the maximum fluorescent intensities of PEI25k/PMMA particles modified with various organic acids. Additionally, the figure illustrates the visual appearance of both the 1 wt % original particle dispersion and the modified particles under ambient light and 365 nm UV light.

In the case of the critic acid-modified PEI25k/PMMA particles, the PEI shell acts as a nanoreactor, facilitating the carbonization of citric acid and in-situ surface passivation. The PEI shell helps to prevent aggregation of the carbon dots and contributes to their long-term stability and shelf life. The construction of fluorescent core-shell particles through incorporating the carbon dots into the second shell is an innovative approach. The resulting fluorescent core-shell particles can exhibit unique photoluminescent properties, making them suitable for various applications such as fluorescent labeling, bioimaging, and optoelectronics.

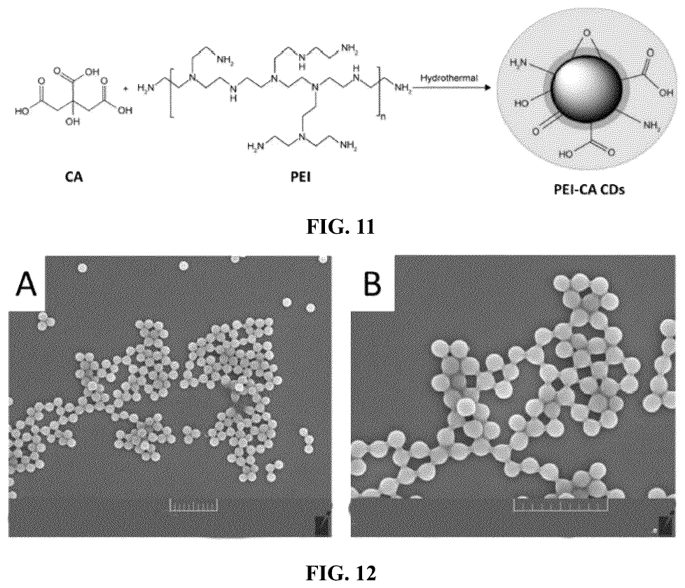

FIG. 11 shows the possible structure of PEI-CA CDs formed between PEI and CA. The PEI-CA CDs possesses serval functional groups on the surface, including 1°, 2°, 3° amine, hydroxyl group (—OH), carbonyl group (C═O), carboxylic acid group (—COOH) and epoxy group.

### Elucidating the Fluorescence Properties of CA-Modified Particles

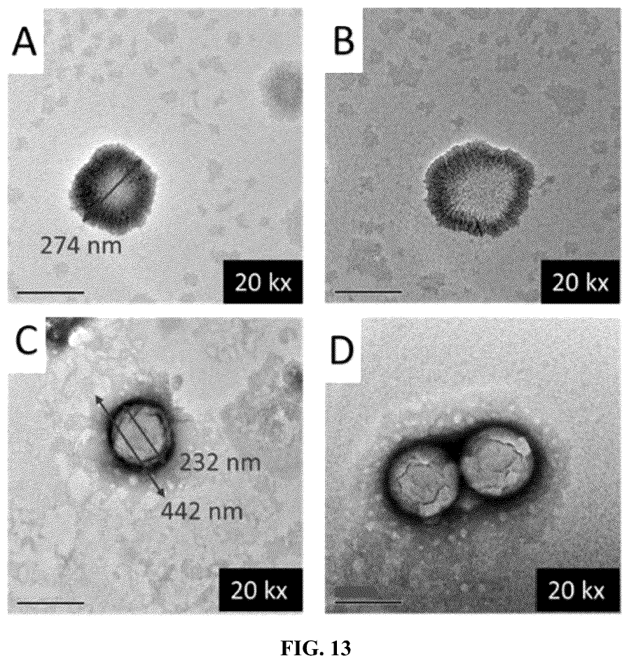

The critic acid-modified PEI25k/PMMA particles were carefully examined by the SEM and TEM. The SEM image (FIG. 12) revealed that the critic acid-modified particles displayed a uniform morphology and had sizes ranging from 320 to 400 nm. These sizes were larger than the original sizes of the PEI25k/PMMA particles, which were in the range of 200 to 280 nm. To further investigate the nanostructure of the particles, TEM analysis was performed. The CA-modified particles were stained with a 0.5% phosphotungstic acid (PTA) solution to enhance the contrast and visibility of the particles. The TEM images in FIG. 13C and D revealed that the particles exhibited a core-shell structure with well-defined boundaries. When comparing the original particles (in FIG. 13A and B), numerous dots were observed on the external PEI shell layer with sizes ranging from 16-35 nm. (FIG. 13D). The presence of dots on the external PEI shell layer suggests that the CA modification has induced changes in the surface morphology of the particles.

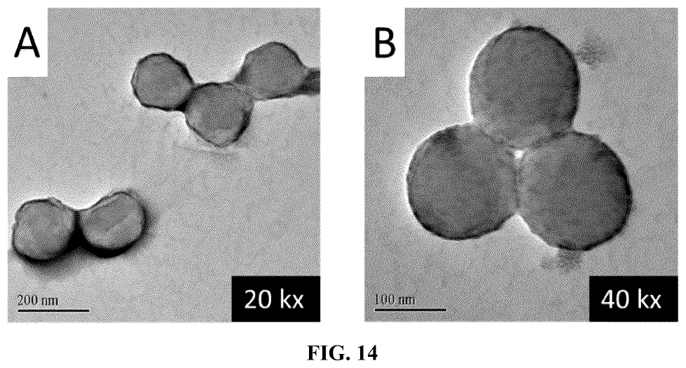

To further elucidate these dots, the particles were subjected to centrifugation at 14000 rpm for 60 min at 0° C. This procedure allowed for the isolation of the dots, which were then analyzed separately. TEM images in FIG. 14 showed that the remaining particles after centrifugation lose all dots.

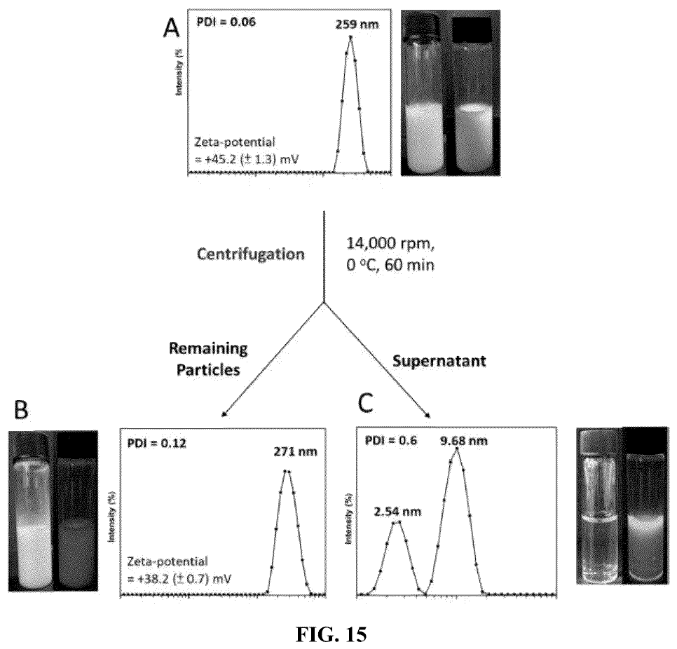

The size of the dots that were separated from the particles and suspended in the supernatant were less than 10 nm as measured by the dynamic light scattering (DLS) (FIG. 15C). It was also observed that the originally CA-modified particles lost their photoluminescent property after centrifugation (FIG. 15B), while the yellowish supernatant collected through centrifugation showed strong fluorescence under 365 nm light (FIG. 15C). Thus, the loss of photoluminescence in the particles after centrifugation suggests that the luminescent properties were primarily associated with the dots that were immobilized on the PEI shell layer of the particles. The bright layer is composed of the luminescent dots that were isolated during centrifugation. These results suggest that the photoluminescence of the CA-modified particles originates from the dots immobilized on the PEI shell layer. Thus, by using a PEI/PMMA particle as reaction platform, the reaction between PEI and CA to generate CDs can take place without the need of high hydrothermal temperature or microwave irradiation.

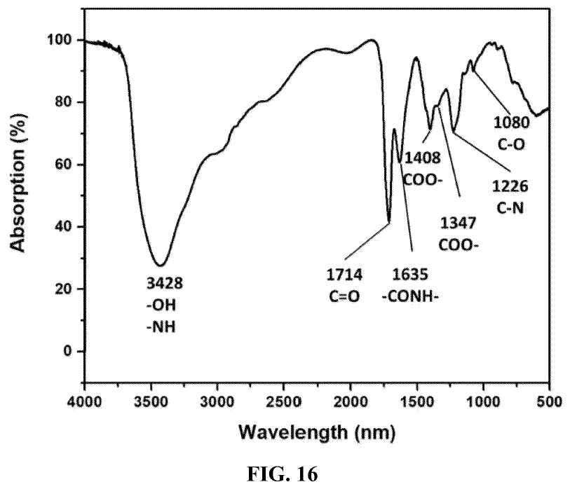

In order to gain insights into the chemical composition of the PEI-CA carbon dots (CDs), FTIR measurements were performed as shown in FIG. 16. The vibration stretchings of O—H and N—H bonds are ascribed to the broad peak at approximately 3428 cm⁻¹. The vibrations of C═O (carbonyl) and amide (—CONH—) are attributed to the peaks at 1715 and 1633 cm⁻¹, respectively. The peaks at 1347 to 1408 cm⁻¹ may be contributed to by COO— groups, while the peaks at 1226 and 1080 cm⁻¹ are associated with C—N and C—O vibrations. The function groups of the CDs matched with the functional groups shown in in FIG. 11.

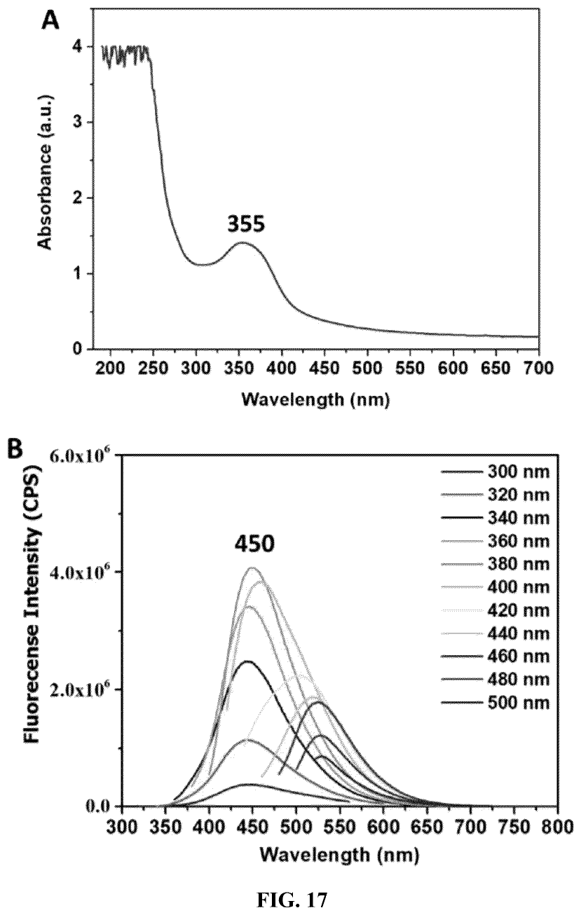

The optical properties of the transparent suspension of PEI-CA carbon dots (CDs) were investigated using UV-vis and fluorescence spectroscopy. The UV-vis spectrum in FIG. 17A revealed the presence of broad absorption peaks ranging from 300 to 400 nm, with a peak observed at 355 nm. This peak at 355 nm corresponds to the n-π* transition associated with the C═O bonding. In FIG. 17B, it was observed that the fluorescent properties of the PEI-CA CDs differed from the CDs in PEI shell of the CA1-PEI25k/PMMA particles. When comparing with the separated CDs and that within the PEI shell of the particles, the maximum excitation of the separated CDs exhibited a red shift from 360 to 380 nm, with the emission maximum changed from 440 to 450 nm. Additionally, when the excitation wavelength was further red shifted from 400 to 500 nm, lower intensity fluorescent emission peaks with longer wavelengths were observed. This indicates the excitation-dependent properties of the CDs, which is a common characteristic of CDs in general. The QY of the CDs measurement was 31 (±2) %. The difference in fluorescent properties observed between the CDs within the PEI shell of the particles and the separated CD suspension can be attributed to environmental changes. When it was in the PEI shell of the particles, the CDs are surrounded by amine groups, including positively charged amines of PEI. However, when it was separated out from the particle in the suspension form, the CDs are surrounded by water molecules. This disparity in the surrounding environment, specifically the variation between —OH and —NH functional groups, may influence the electronic state of the CDs, consequently leading to alterations in their fluorescent intensity.

### Effect of PEI Molecular Weight on Citric Acid Modification

This study compares two types of PEI/PMMA particles, namely PEI25k/PMMA and PEI750k/PMMA. These particles were synthesized using different branched polyethyleneimine (PEI) molecules with molecular weights of 25k and 750k, respectively. The study focuses on evaluating the effects of PEI molecular weight with 1 wt % citric acid modification on the size, size distribution, and fluorescence properties of the particles.

### Size and Surface Charge of PEI25k/PMMA and PEI750k/PMMA Particles Before and After CA Modification

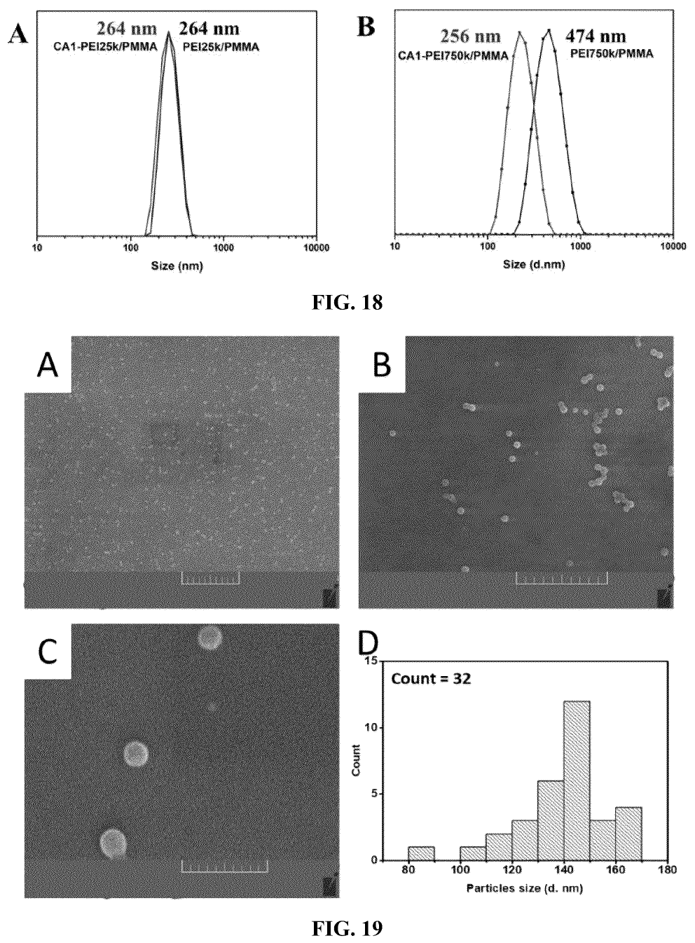

FIG. 18 and Table 4 show the size, size distribution and zeta-potential of the PEI/PMMA particles prepared by 25k and 750k PEI before and after 1 wt % of CA modification. Results showed that the average particles size of the PEI25k/PMMA particles is around 264 nm with narrow size distribution (PDI=0.04). After modification with CA, the CA-modified PEI25k/PMMA particles have almost the same size with slight increase in size distribution (PDI=0.06) (FIG. 18A). These results revealed that the size of PEI25k/PMMA particles in aqueous was not affected after modification by 1 wt % of CA. On the other hand, the particle size of PEI750k/PMMA particles was considerably reduced from 598 to 256 nm after reacting with 1 wt % CA (FIG. 18B). Results showed that PEI750k/PMMA have larger particles size than the PEI25k/PMMA in aqueous, which is due to the higher molecular weight of branched PEI polymer chains at the particles. The water-soluble PEI can extend freely in the aqueous medium and that would result in a high hydrodynamic diameter under DLS measurement. After modification with CA, the reduction of the hydrodynamic diameter of PEI750k/PMMA particles can be attributed to two possible reasons. 1) Some PEI polymer chains on the surface of the particles were consumed through reaction with citric acid to form passivated CDs; and 2) compression of PEI shells due to the ionic complexation between the positively charged amine groups of PEI and the negatively charged carboxylic acid groups of CA. Based on the zeta-potential measurements presented in Table 4, the initially high surface charges of both particles, exceeding +40 mV, were reduced to a range of +23 to +26 mV after the modification reaction. This reduction in surface charge can be attributed to the ionic complexation between the amine groups of PEI and the carboxylic acid groups of CA, leading to a decrease in overall electrostatic repulsion. The reduction in surface charge of the CA-PEI/PMMA particles resulted in the aggregation of the particles after settling for 24 hours or longer periods. This would be reduced by optimization of the particles which will be resented in the following sections.

TABLE 4
Summary of particles size and zeta-potential of PEI25k/PMMA
and PEI750k/PMMA before and after 1 wt/wt of CA modification

| | Particles size | | zeta-potential |
|---|---|---|---|
| Particles Name | (d · nm) | PDI | (mV) |
| PEI₂₅ₖ/PMMA | 264 (±1) | 0.04 | +49.2 (±0.2) |
| CA1-PEI₂₅ₖ/PMMA | 264 (±2) | 0.06 | +23.8 (±1.9) |
| PEI₇₅₀ₖ/PMMA | 598 (±13) | 0.17 | +43.7 (±0.1) |
| CA1-PEI₇₅₀ₖ/PMMA | 256 (±4) | 0.03 | +25.3 (±0.9) |

### Morphologies of PEI25k/PMMA and PEI750k/PMMA Particles Before and After CA Modification

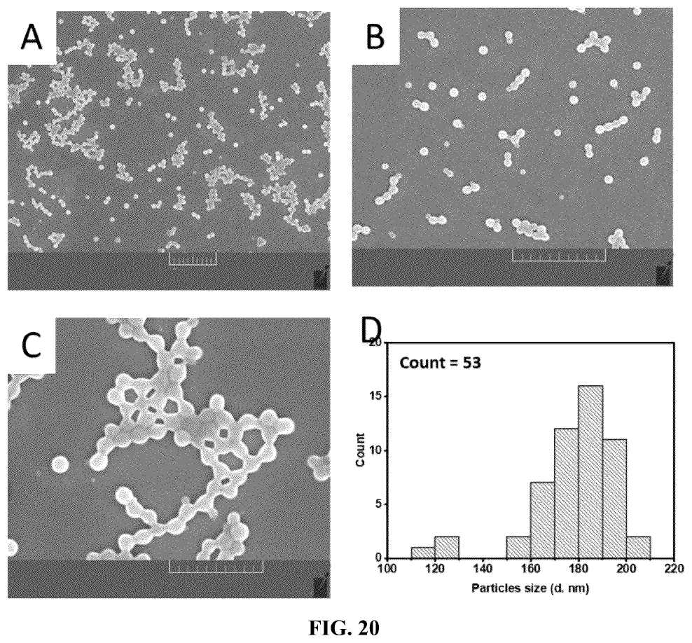

TEM and SEM imaging techniques were employed to analyze the morphological characteristics of both PEI25k/PMMA and PEI750k/PMMA particles, both before and after their modification with CA. The SEM and TEM images of the previously discussed PEI25k/PMMA and CA-modified PEI25k/PMMA particles are presented in FIGS. 6, 12, and 13. FIG. 19A-C displays the SEM images of PEI750k/PMMA particles, which exhibit spherical and uniform shapes with sizes ranging from 150 to 210 nm in the dry state (FIG. 19D). Unlike the PEI25k/PMMA particles, the PEI750k/PMMA particles display a notable three-layer structure in the TEM images (FIG. 20A-B). This distinction arises from the higher molecular weight of PEI750k in comparison to PEI25k, causing the longer PEI chains to have enhanced flexibility and swelling or extending around the particles. FIG. 20C and D show the TEM images of CA1-PEI750k/PMMA particles, revealing the presence of carbon dots (CDs) on the surfaces of the particles with sizes ranging from 14 to 40 nm. Interestingly, it was observed that the CA1-PEI750k/PMMA particles exhibited a higher quantity of CDs compared to the CA1-PEI25k/PMMA particles. This increase in the number of CDs can be attributed to the larger molecular weight of PEI750k, which results in a thicker PEI shell surrounding the particles. Consequently, a thicker PEI shell allows for a greater number of CD to be accommodated on the particle surfaces.

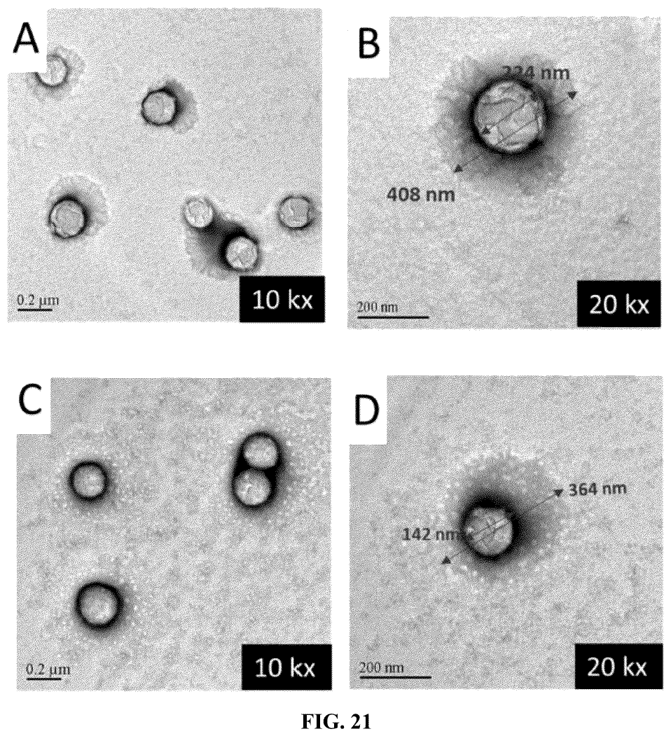

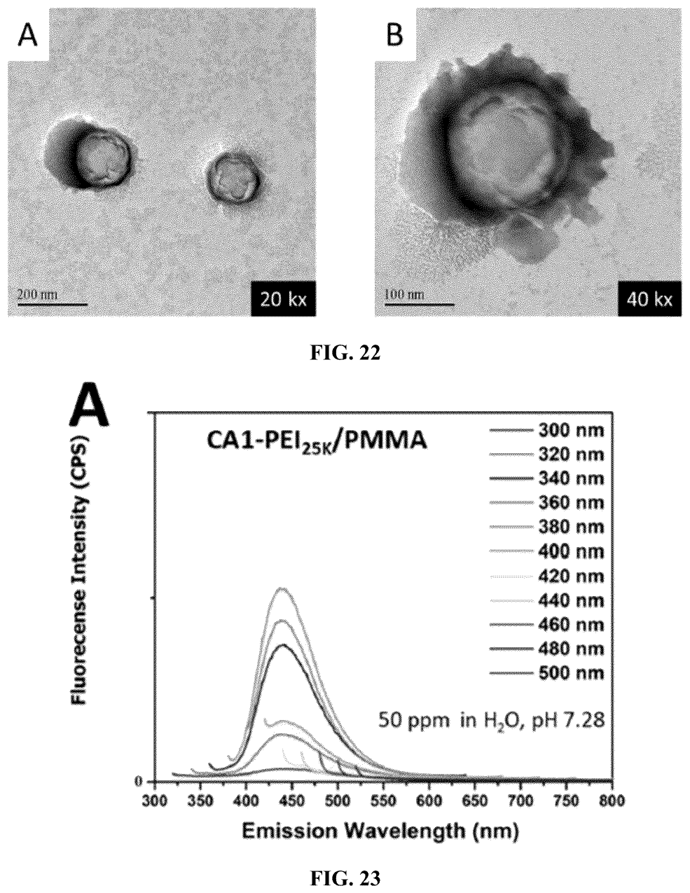

To further get insight into these carbon dots (CDs), the CA1-PEI750k/PMMA particles was subjected to a centrifugation treatment with a rotational speed of 14,000 rpm for 60 minutes at 0° C. FIG. 21 illustrates the TEM images of the remaining CA1-PEI750k/PMMA particles collected after centrifugation, where the CDs are no longer visible within the particle shell. The centrifugation process effectively removed or separated the loosely attached or unbound carbon dots from the surfaces of the particles.

### Photoluminescent Intensity of the CA-Modified PEI750K/PMMA Particles

As depicted in FIG. 23A and B, the fluorescent spectra of both CA1-PEI25k/PMMA and CA1-PEI750k/PMMA particles exhibited excitation-independent fluorescence characteristics when excited by light ranging from 300 to 400 nm. Notably, intense emissions were observed upon excitation with light in the range of 340 to 380 nm. Both types of particles displayed a peak emission at 440 nm when excited with 360 nm light (FIG. 23A).

Furthermore, FIGS. 23A and B demonstrate that particles synthesized with 750k PEI exhibited higher emission intensity compared to those synthesized with 25k PEI, which aligns with previous findings indicating a higher number of carbon dots formed on the PEI shell. Consequently, this increased presence of carbon dots contributes to a higher emission intensity.

Quantum Yields of Carbon Dots Isolated from CA-Modified PEI750/PMMA Particles

The quantum yields of the carbon dots isolated from CA1-PEI25k/PMMA and CA1-PEI750k/PMMA were measured to be 31% (±2%) and 25% (±1%), respectively. These results indicate that the carbon dots obtained from CA1-PEI25k/PMMA particles have a higher quantum yield compared to those produced in CA1-PEI750k/PMMA particles. The difference in quantum yields between the two types of particles may be attributed to various factors, including differences in the carbon dot formation process, the chemical environment, or the specific properties of the carbon dots formed by the different PEI molecular weights. The specific mechanisms underlying this difference would require further investigation and characterization.

### Optimization of Fluorescent Core-Shell Particles Using PEI-Based Core-Shell Particles

Evidence for supporting the origin of fluorescence from the carbon dots formed through the reaction between CA and the PEI-based particles is provided herein. Moreover, it was observed that particles with a thicker shell exhibited a higher fluorescent intensity, suggesting a correlation between the number of carbon dot and the emitted fluorescence intensity.

In order to obtain a stable fluorescent particle dispersion with uniform size and narrow size distribution, further optimization studies were conducted using 750k PEI as the starting material for preparing PEI-based particles, followed by a modification reaction with CA. Several parameters were investigated and optimized, including:
1. The molar ratio of citric acid (CA) to PEI used in the modification reaction.
2. The core to shell ratio of the PEI-based core-shell particles.
3. The chemical compositions of the core of the PEI-based core-shell particles.

### Effects Study of the Degree of Modification by CA on PEI750k/PMMA Particles

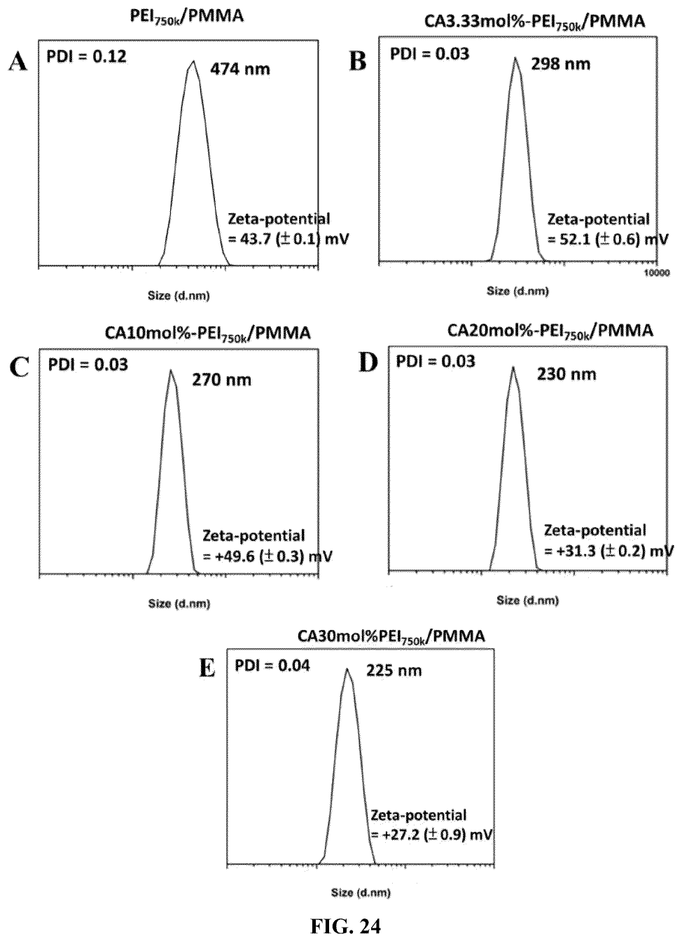

Presented herein is the stability of PEI750k/PMMA particles (PEI:MMA=1:3 wt/wt) was greatly reduced after reacting with 1 wt/wt of CA. To achieve stable fluorescent core-shell particles, the effect of degree of modification by CA on PEI750k/PMMAparticles was investigated by varying the amount of CA from 3.33-30 mol % to PEI. FIG. 24A-E showed the particles size, size distribution and zeta-potential of PEI750k/PMMA and that reacted with 3.33-30 mol % to PEI of CA. Results showed that the size of the PEI750k/PMMA particles was highly affected by the amount of CA in the reaction. The size of PEI750k/PMMA particles were decreased from 474 to 298 nm when reacted with 3.33 mol % of CA and ultimately decreased to 225 nm when treating with 30 mol % of CA. The modification reaction was presumed to take place on the PEI shell of the particles. As a result, the measurements obtained through dynamic light scattering (DLS) reflected the hydrodynamic diameter of the particles, which could also be influenced by the thickness of the PEI layer. Therefore, the PEI shell thickness was reduced by the modification of CA. Moreover, the zeta-potential measurement also provides evidence of the modification on the PEI shell. When reacting with 3.33 and 10 mol % of CA, the zeta-potential of PEI750k/PMMA particles increases provide that all particle was measured at c.a. pH 6. This can be attributed to the protonation of amine groups on the particle surface due to the presence of carboxylic acid groups from the citric acid, resulting in an increase in positive charge. However, when reacting with higher concentrations of citric acid, such as 20 and 30 mol %, the zeta-potential of the particles can indeed decrease. This phenomenon can be attributed to the presence of excessive carboxylic acid groups, which may lead to the formation of ionic complexes with the amine groups present on the particle surface. The formation of these complexes can result in a decrease in the overall zeta-potential of the particles. The binding of the carboxylic acid groups to the amine groups can neutralize the positive charge on the particle surface, leading to a decrease in the electrostatic repulsion between particles. Consequently, the zeta-potential, which is a measure of the magnitude of this electrostatic repulsion, decreases. Thus, the particles will not be stable and eventually aggregated.

TABLE 5
Summary of CA20 mol %-PEI750k/PMMA
particles with various shell

| | Particles size | | zeta-potential |
|---|---|---|---|
| Particle | (d · nm) | PDI | (mV) |
| PEI₇₅₀ₖ/PMMA | 474 | 0.12 | +43.7.6 (±0.1) |
| CA3.33 mol %-PEI₇₅₀ₖ/PMMA | 298 | 0.03 | +52.1 (±0.6) |
| CA10 mol %-PEI₇₅₀ₖ/PMMA | 270 | 0.03 | +49.6 (±0.3) |
| CA20 mol %-PEI₇₅₀ₖ/PMMA | 230 | 0.03 | +31.3 (±0.2) |
| CA30 mol % PEI₇₅₀ₖ/PMMA | 225 | 0.04 | +27.2 (±0.9) |

The fluorescent spectra of the PEI750/PMMA particles modified by various amount of citric acid ranging from 3.33 to 30 mol % of CA to PEI are presented in FIG. 25. The increase in fluorescent intensity is not obvious when the particles were modified by 3.33 mol % of CA (FIG. 25A). When the amount of CA increased from 10 to 30 mol % to PEI, the fluorescent intensity was highly enhanced (FIG. 25B-D). A strong blue color can be observed under 365 nm light excitation (FIG. 25F). They also possessed excitation dependent fluorescence property when excited by 300 nm to 500 nm light and emitted high intensity light when excited by 340 nm to 400 nm light. The maximum emissions of those three particles are similar, which is around 440-450 nm when excited by 360 nm light. Among the three particles, the one modified by 20 mol % CA displayed the highest fluorescent intensity. Thus, further optimization reaction was done by using 20 mol % of CA to modification the PEI-based particles.

Effects of Surface Modification of PEI/PMMA Particles with Various Shell Thickness by Citric Acid

This study aimed at studying the effects of CA modification of the PEI750k/PMMA particles on shell thickness. The shell thickness of the particles can be varied by the weight ratio of PEI to monomer in the polymerization. Theoretically, the more PMMA the particles composed of, the larger core and thinner shell the particles have. Therefore, four weight ratios of PEI to MMA from 1:0.5, 1:1, 1:2 and 1:3 were investigated and compared. The summary of the monomer conversion, composition of the particle, particle size, distribution and surface charge before and after modification are tabulated in Table 6 and Table 7.

TABLE 6
Summary of PEI750k/PMMA particles with various shell thickness

| | | Percent- | | | |
|---|---|---|---|---|---|
| | | age of | | | |
| | | PEI in | | | |
| | | PEI/PMMA | Particles | | zeta- |
| PEI:MMA | Conversion | particles | size | | potential |
| (wt/wt) | (%) | (wt %) | (d · nm) | PDI | (mV) |
| 1:0.5 | 93 | 83.3 | 389 | 0.12 | +56.4 (±0.9) |
| 1:1 | 100 | 50 | 419 | 0.10 | +52.3 (±0.7) |
| 1:2 | 98 | 33.8 | 425 | 0.10 | +50.8 (±0.1) |
| 1:3 | 100 | 25 | 474 | 0.12 | +43.7 (±0.1) |

TABLE 7
Summary of CA20 mol %-PEI750k/PMMA
particles with various shell

| PEI:MMA | Particles size | | zeta-potential |
|---|---|---|---|
| (wt/wt) | (d · nm) | PDI | (mV) |
| 1:0.5 | 112 & 474 | 0.32 | +23.6 (±1.1) |
| 1:1 | 211 & 1970 | 0.24 | +23.9 (±0.3) |
| 1:2 | 260 & 1192 | 0.48 | +23.5 (±0.2) |
| 1:3 | 240 | 0.03 | +31.3 (±0.2) |

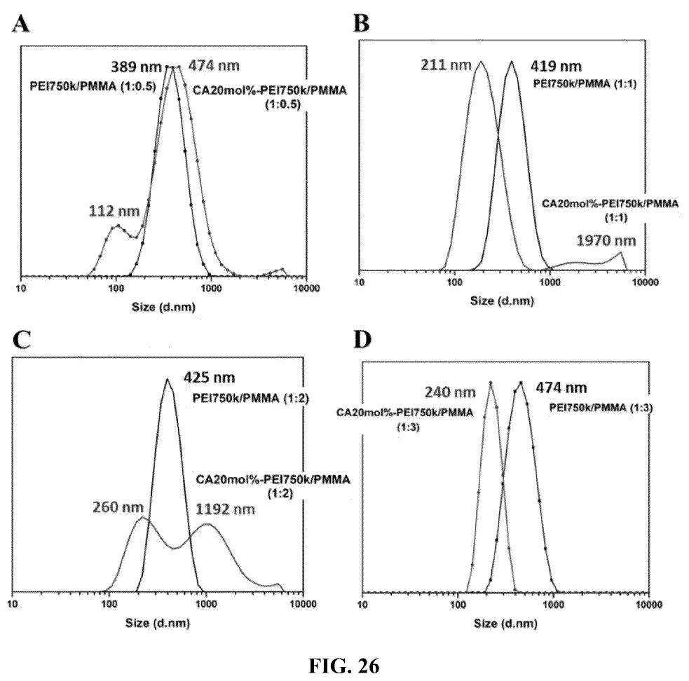

The size distributions and polydispersity indexes (PDIs) of PEI750k/PMMA particles with different PEI to MMA ratios are presented in FIG. 26 and Table 6. The results reveal that increasing the amount of MMA increases the size of the particles from 389 nm to 474 nm, due to the formation of larger PMMA core. It is important to note that all four particle samples exhibit narrow size distributions, as indicated by the low PDI values of 0.1. These narrow size distributions suggest a high degree of uniformity in the particle sizes within each sample. Furthermore, the particles demonstrate excellent stability in an aqueous environment. The zeta-potential measurements indicate an increase in the positive surface charge from +43.7 to +56.4 mV as the ratio of PEI in the particles is increased. Hence, by adjusting the weight ratio of PEI to MMA, it becomes possible to alter the thickness of the PEI shells. Increasing the PEI to MMA ratio results in smaller particle sizes and thicker PEI shells. When reacting 20 mol % CA with particles synthesized with PEI to MMA weight ratios of 1:0.5, 1:1, and 1:2, larger particle sizes with broad size distributions were formed (FIG. 26). The occurrence of these larger particles can be attributed to particle aggregation, which is caused by the destabilizing effect of the carboxylic acid groups present in citric acid. This instability is evident by the decrease in the surface charges of the particles from ≥50 mV to ≤30 mV (Table 7).

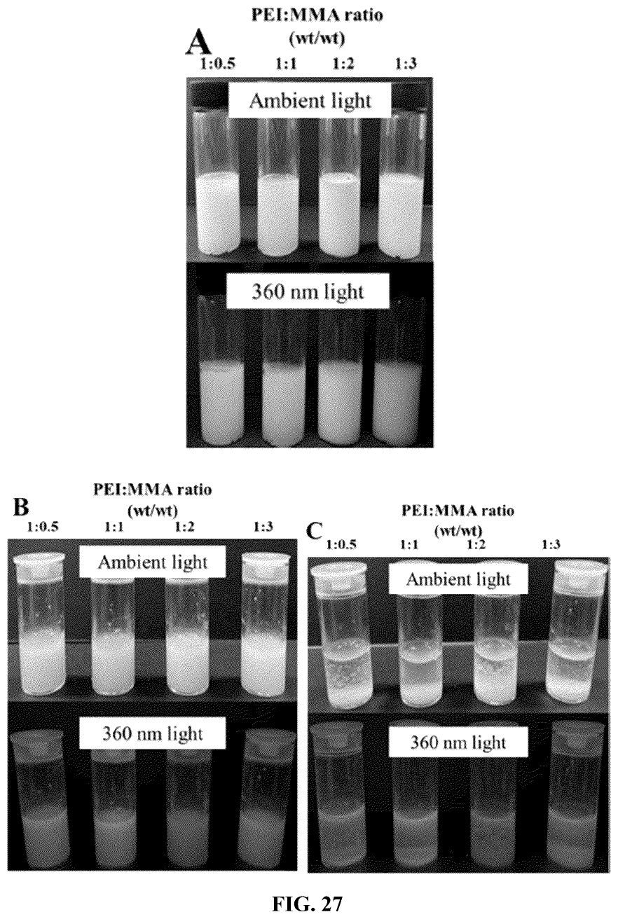

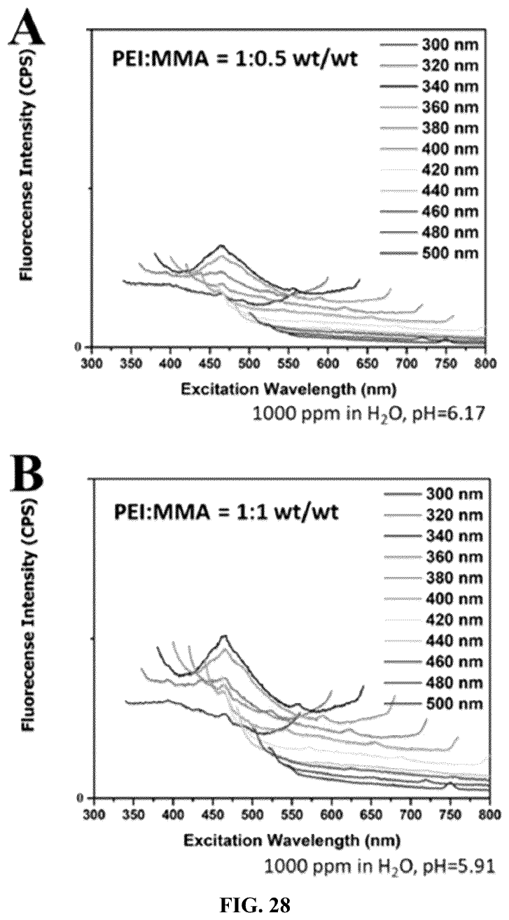

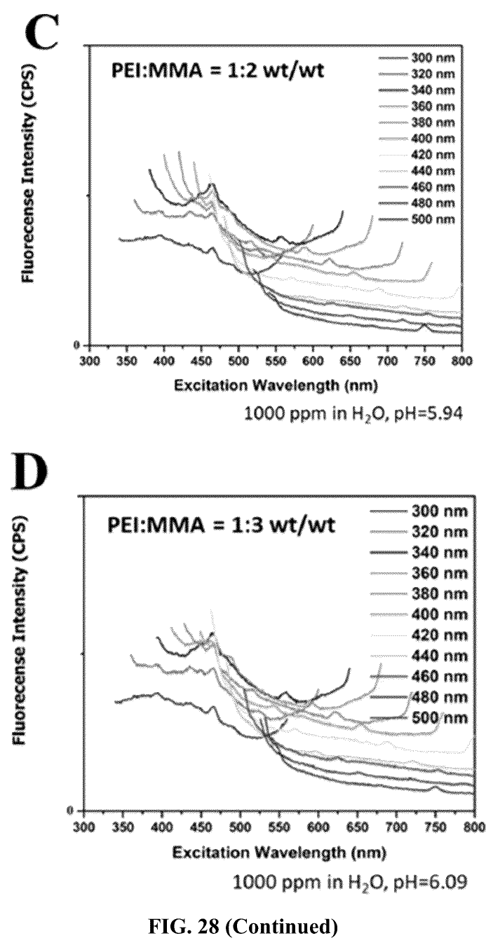

The instability of the particles was observed when the particle dispersion was left at room temperature for 24 hours. FIG. 27A shows that the particles before modification were initially stable in the dispersion. In FIG. 27B, freshly prepared CA-modified particles also remained stable without any signs of settling. However, FIG. 27C reveals that the particles became unstable and eventually settled after 24 hours. To address this instability issue, attempts were made to solve the problem by changing the core composition, which will be discussed in a later section.

FIG. 27A shows images of the PEI750k/PMMA particles synthesized with varying PEI:MMA weight ratios of 1:1, 1:2, 1:3, and 1:4 under 365 nm light excitation. None of the PEI750k/PMMA particle dispersions exhibit strong fluorescence. Fluorescent spectra of these particles also show no substantial fluorescence upon excitation. Only very weak emission peak around 460 nm was observed when excited within the range of 320 to 360 nm. This weak emission may be attributed from the immobilized PEI on the particle shell.

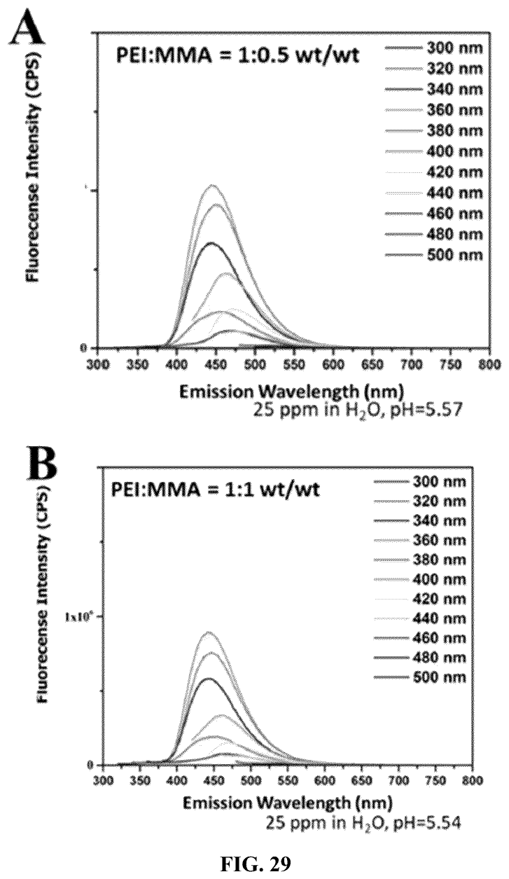

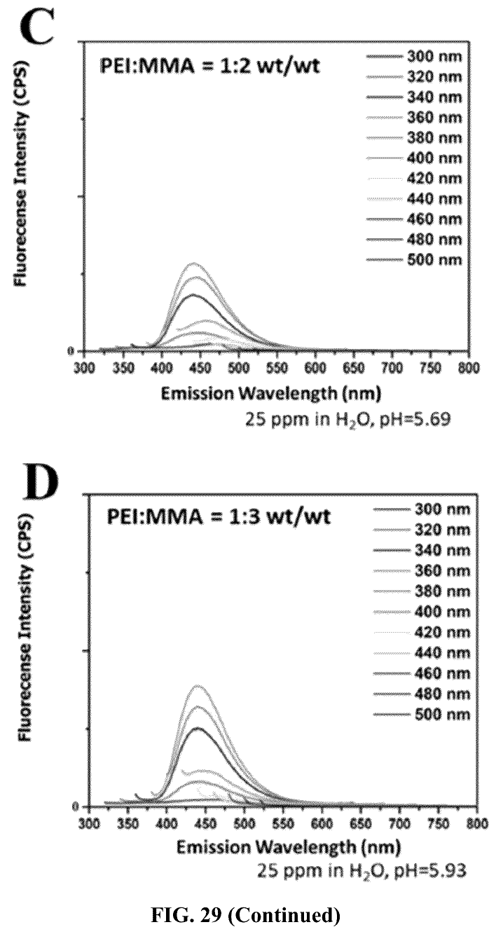

After being modified with 20 mol % of CA to PEI, the particles exhibited significantly enhanced fluorescent intensity (FIG. 29). The fluorescent behavior of the particles with different core-shell ratios was found to be similar. These particles demonstrated excitation-dependent fluorescence characteristics, displaying fluorescence when excited by light ranging from 300 to 500 nm, and particularly strong fluorescence when excited by light within the range of 340 to 400 nm. FIG. 30 provides a comparison of the maximum fluorescent intensities observed when the particles were excited by light ranging from 300 to 420 nm.

The PEI750k/PMMA particles (PEI:MMA=1:0.5 wt/wt) with a thicker PEI shell demonstrated the highest fluorescence intensity after being modified with 20 mol % of CA to PEI. This increased fluorescence can be attributed to the higher PEI content within these particles, allowing for a greater amount of CA to react during the modification process. As a result, more CDs are generated, leading to enhanced fluorescence.

In summary, the addition of 20 mol % CA to the PEI-modified particles led to a notable enhancement in their fluorescent properties. The particles with different core-shell ratios exhibited similar excitation-dependent fluorescence, with the PEI750k/PMMA (PEI:MMA=1:0.5 wt/wt) particles displaying the strongest fluorescence due to their higher PEI content.

### Effects of Chemical Composition of the Core on CA Surface Modification

This study aims to investigate the influence of the core composition of PEI750k/P(MMA-co-BA) particles on the properties of citric-acid-modified particles. The weight ratios of MMA to BA were varied as 10:0, 9:1, 7:3, and 5:5. Altering the BA to MMA ratio theoretically impacts the physical properties of the particles, such as increasing flexibility and reducing the glass transition temperature (Tg) of the particle cores. It is of interest to determine whether the composition of the particle cores affects the fluorescent properties, particle size, and particle stability. Four different PEI750k/P(MMA-co-BA) particle compositions were prepared and compared after being modified by citric acid. The PEI to monomer weight ratio was fixed at 1:3, and the specific details of the particles can be found in Table 8 and 9.

TABLE 8
Summary of PEI750k/P(MMA-co-BA) particles
with different MMA to BA ratio (wt/wt)

| | | Monomer | Particles | | zeta- |
|---|---|---|---|---|---|
| | | Conversion | size | | potential |
| Particles | MMA:BA | (%) | (d · nm) | PDI | (mV) |
| PEI₇₅₀ₖ/PMMA (10:0) | 10:0 | 100 | 474 | 0.12 | +43.7 (±0.1) |
| PEI₇₅₀ₖ/P(MMA-co-BA) (9:1) | 9:1 | 95 | 443 | 0.05 | +47.8 (±0.9) |
| PEI₇₅₀ₖ/P(MMA-co-BA) (7:3) | 7:3 | 95 | 303 | 0.09 | +46.4 (±0.5) |
| PEI₇₅₀ₖ/P(MMA-co-BA) (5:5) | 5:5 | 96 | 295 | 0.14 | +46.9 (±0.8) |

TABLE 9
Summary of PEI750k/P(MMA-co-BA) particles with different
MMA to BA ratio (wt/wt) after modified by 20 mol % CA

| | Particles size | | zeta-potential |
|---|---|---|---|
| Particles Name | (d · nm) | PDI | (mV) |
| CA20 mol %-PEI₇₅₀ₖ/PMMA (10:0) | 230 | 0.02 | +31.3 (±0.2) |
| CA20 mol %-PEI₇₅₀ₖ/P(MMA-co-BA) (9:1) | 268 | 0.03 | +33.0 (±0.8) |
| CA20 mol %-PEI₇₅₀ₖ/P(MMA-co-BA) (7:3) | 193 | 0.04 | +30.2 (±0.1) |
| CA20 mol %-PEI₇₅₀ₖ/P(MMA-co-BA) (5:5) | 187 | 0.09 | +28.0 (±0.7) |

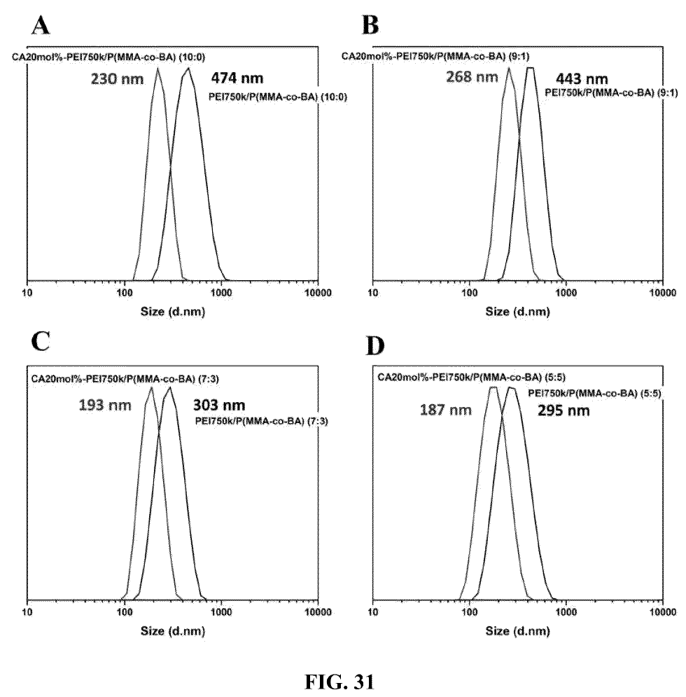

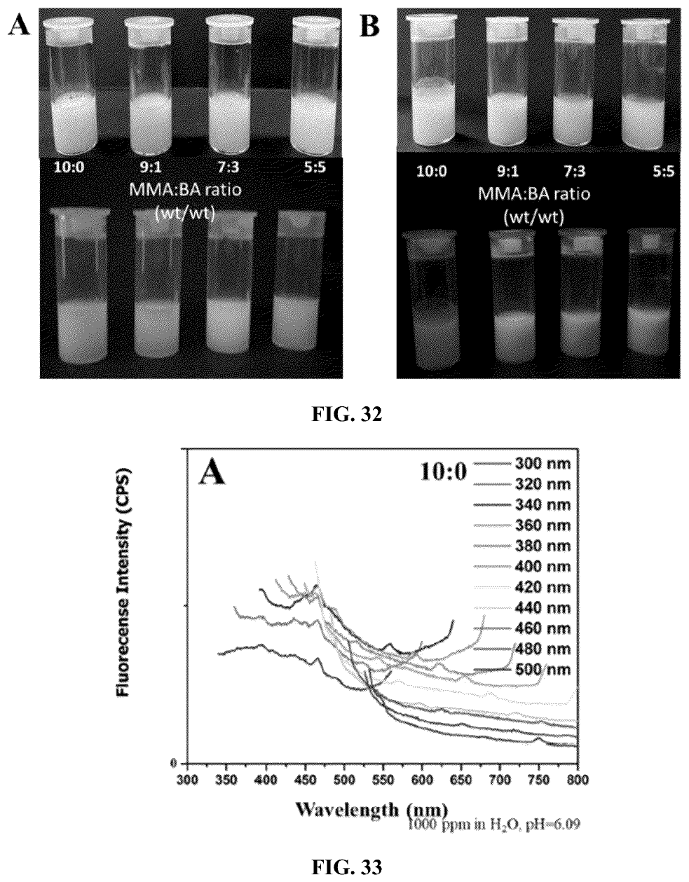

The size distributions and polydispersity index (PDI) of the PEI750k/P(MMA-co-BA) particles are shown in Table 8 and FIG. 31. It is observed that, for a constant PEI to monomer weight ratio of 1:3, the particle size decreases with an increase in the BA content. Specifically, as the weight ratio of MMA to BA decreases from 10:0 to 5:5, the particle size decreases from 474 nm to 295 nm. The decrease in particle size with increasing BA content suggests that the presence of BA influences the particle formation process, potentially affecting the nucleation and growth mechanisms. Furthermore, the size distributions of the particles, both before and after modification, were found to be narrow, as indicated by the PDI values ranging from 0.02 to 0.14. The narrow size distribution implies a relatively uniform particle size within each sample, indicating a high level of control in the particle synthesis process.

On the other hand, the surface charges of the particles of P(MMA-co-BA) were higher than of PMMA only. The surface charges of the particles with different MMA to BA ratio (wt/wt) were around +46 to +47 mV. In FIG. 31A, the PEI750k-P(MMAco-BA) particle shows highly stable in aqueous. More importantly, the 20 mol % CA-modified particles with P(MMA-co-BA) core are much more stable than that of PMMA core in aqueous. The zeta-potential of the CA20%-PEI750k/P(MMA-co-BA) are, ranging from +28 to +33 mV.

The particles with P(MMA-co-BA) as the particle core exhibited higher surface charges compared to PMMA-only particles. The surface charges of the particles with different MMA to BA ratios (wt/wt) had zeta-potential values around +46, which were 3-4 mV higher than those of PEI750k/PMMA particles. Therefore, the enhanced stability of the 20 mol % CA-modified particles with P(MMA-co-BA) as the particle core, compared to the PMMA core particles in the aqueous medium, can be attributed to the reduced particle size.

### Optical Properties of PEI750k/P(MMA-co-BA) Particles Before and After Modified by 20 Mol % of CA

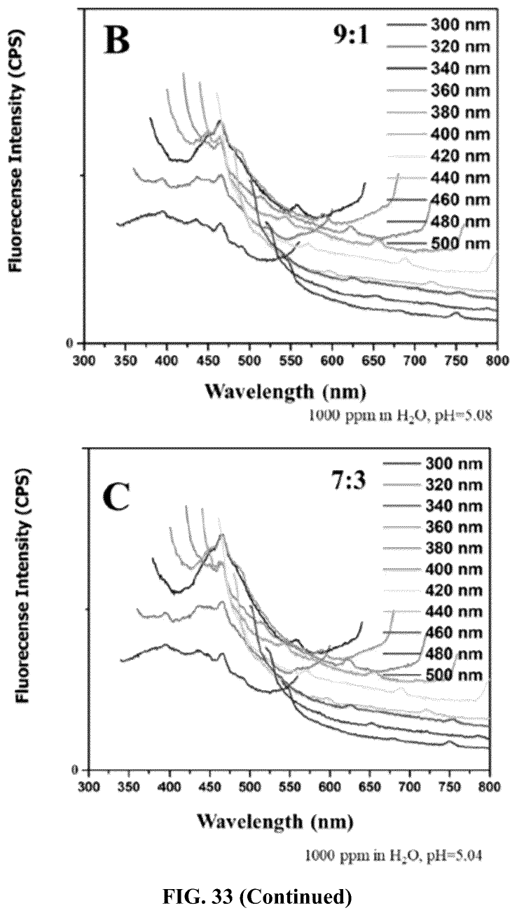

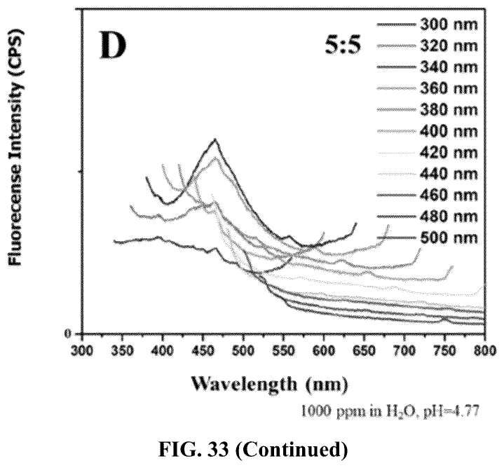

FIG. 33 shows the fluorescent spectra of PEI750k/PMMA and PEI750K/P(MMAco-BA) particles. The fluorescent intensity of the PEI-based core-shell particles, utilizing PMMA or P(MMA-co-BA) as the particle core, exhibits similarity. Notably, all particles exhibit a weak fluorescent emission at around 450-460 nm when excited by 340 and 360 nm light. The introduction of PBA into the particle core does not result in a significant enhancement of the fluorescent properties because PBA may not possess strong inherent fluorescent properties. Therefore, incorporating PBA into the particle core would not contribute significantly to the overall fluorescent properties.

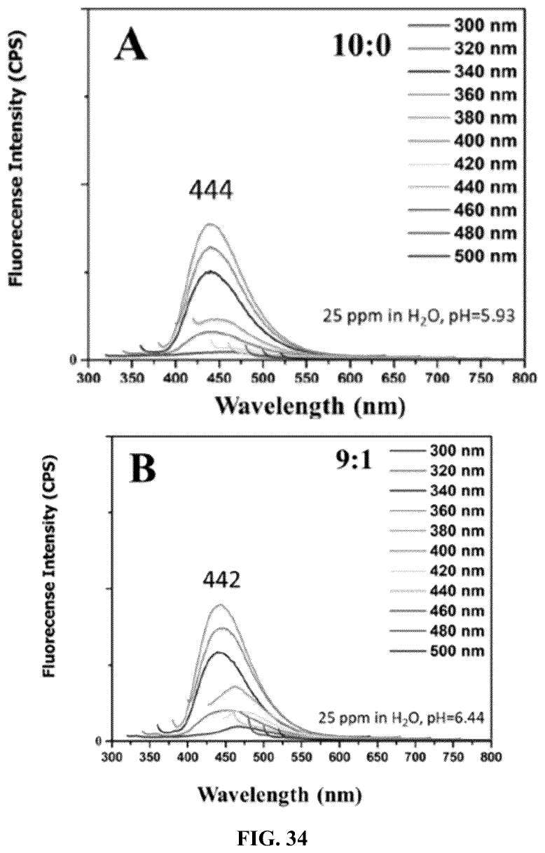

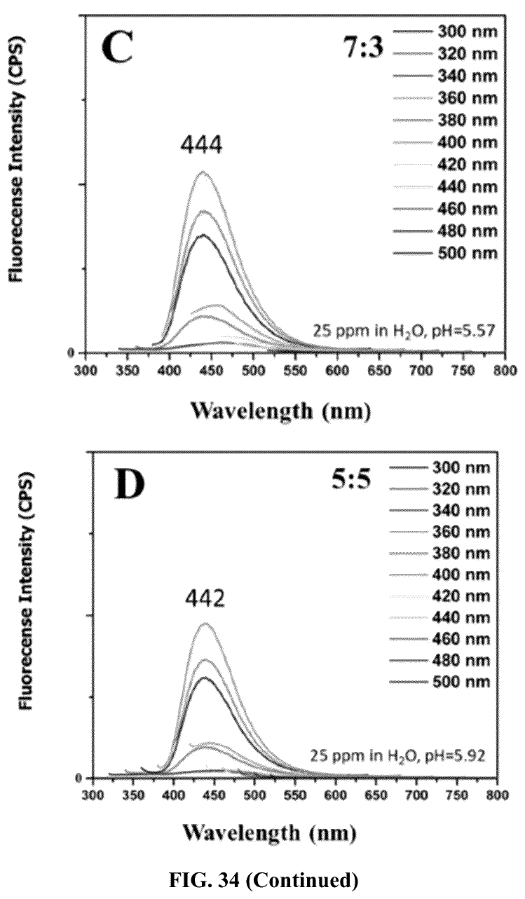

Upon modifying the particles with 20 mol % CA to PEI, a significant increase in fluorescent intensity was observed, similar to the findings in previous section. When considering the four particles with varying MMA to BA ratios (wt/wt) after modification, it was found that the particles with P(MMA-co-BA) as the core exhibited higher fluorescent intensities compared to those with PMMA as the particle core. Notably, when the four particles were excited by light within the range of 320-420 nm, high fluorescent emission peaks were measured (FIG. 34). The emission peaks varied depending on the excitation wavelength, indicating that the particles possess excitation-dependent fluorescence.

Interestingly, all four particles exhibited the same emission at 440 nm when excited by 340, 360 and 380 nm light where the 360 nm incident light would result in the strongest fluorescent emission. By comparing the maximum fluorescent intensities of the particles (refer to FIG. 35), it was found that the particles with an MMA:BAratio of 7:3 (wt/wt) in the core displayed the highest fluorescent intensity among all the particles.

### Properties of CA20 Mol %-PEI750k/P(MMA-co-BA) Particles

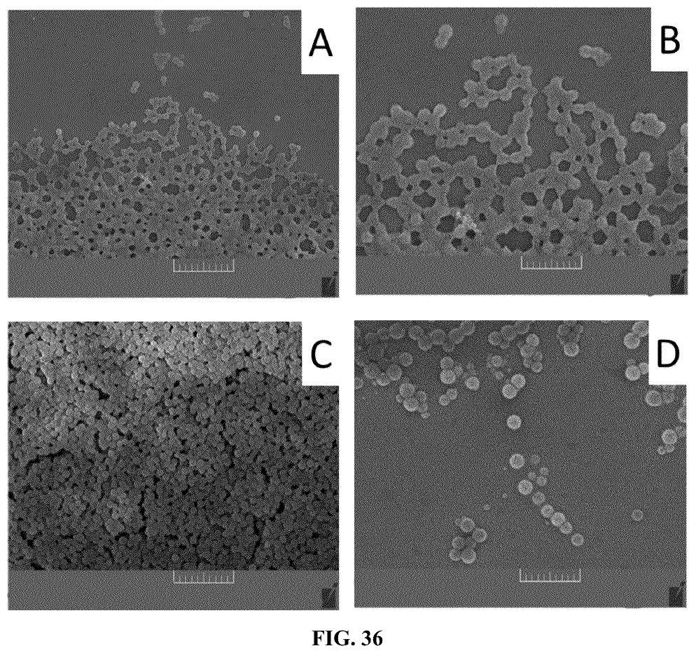

Previous sections presented a comprehensive study of the fluorescent core-shell particles using PEI-based core-shell particles. Through optimization, it was determined that the composition consisting of 20 mol % (to PEI) of CA modified PEI750k/P(MMAco-BA) particles with a core-shell weight ratio of 1:3 and an MMA:BA weight ratio of 7:3, exhibited the highest fluorescent intensity. Furthermore, these particles demonstrated excellent stability in an aqueous environment. Provided herein is a detailed characterization of the particles using various measurement technique, including TEM, SEM, TGA as well as solid and aqueous fluorescent spectroscopies. SEM images of the PEI750k/P(MMA-co-BA) particles before and after modification with 20 mol % CA are shown in FIG. 36. In FIG. 36A and B, it can be observed that the particles tend to merge together upon drying. This phenomenon contrasts with the behavior observed in the case of PEI25k/PMMA and PEI750k/PMMA particles. The coalescence or merging of particles in the PEI750k/P(MMA-co-BA) system can be attributed to the incorporation of poly(n-butyl acrylate) (PBA) into the particle core. The PBA is a low glass transition temperature (Tg) polymer that facilitates particle deformation during the drying process. This deformation promotes the formation of a homogeneous layer by joining individual particles together, resulting in the observed merging phenomenon.

In FIG. 36C and D, the observation of reduced merging phenomenon in the CA-modified PEI750k/P(MMA-co-BA) particles suggests that the formation of carbon dots within the PEI shell could be responsible for this effect. The presence of carbon dots may immobilize the PEI polymer, leading to increased rigidity of the shell. This increased rigidity limits the ability of the PEI shell to diffuse between particles. As a result, the individual structure of the particles is maintained during the drying process, and collapse or agglomeration is hindered.

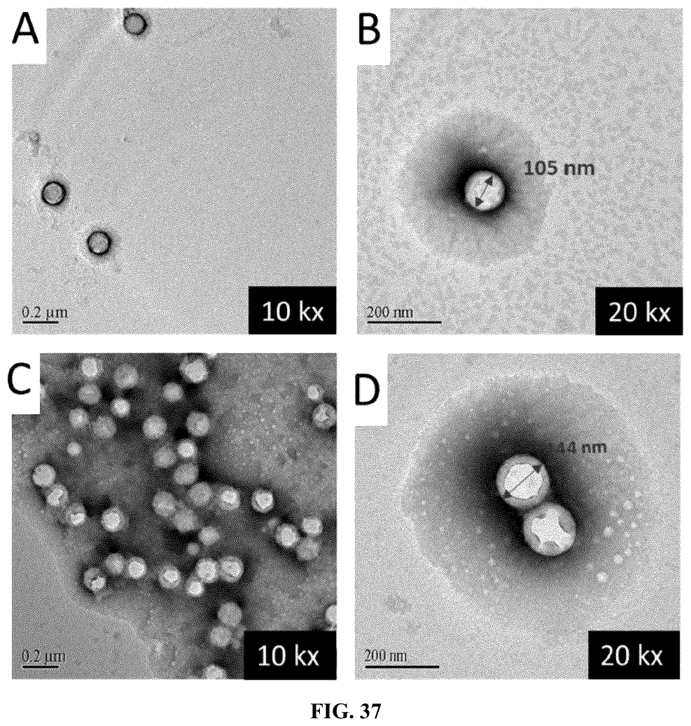

FIG. 37 shows TEM images of PEI750k/P(MMA-co-BA) particles before and after modification with 20 mol % CA. In FIG. 37A and B, the particles exhibit a distinct three-layer structure, which consists of the following components: Outer shell: This layer is composed of a hairy PEI polymer (grey color). Middle layer: The middle layer is comprised of a PEI750k/P(MMA-co-BA) graft copolymer (dark color). Inner core: The innermost layer consists of a P(MMA-co-BA) copolymer (white color). In FIG. 37C and D, the 20 mol % CA-modified PEI750k/P(MMA-co-BA) particles also display the same well-defined three-layer structure as the original particles. However, extra white dots are observed, indicating the presence of carbon dots within the PEI layer of the particles after reacting with CA.

Therefore, it can be concluded that the presence of CA influences the behavior of the PEI750k/P(MMA-co-BA) particles, leading to different film formation characteristics. The presence of BA in the particle core promotes particle merging and the formation of a homogeneous layer, while the presence of CA at the PEI shell inhibits particle deformation and helps retain the individual structure of the particles during drying.

### Composition Determination Using Thermogravimetric Analysis (TGA) and Derivative Thermogravimetry (DTG)

Thermogravimetric analysis (TGA) is a technique used to study the thermal behavior and stability of materials as a function of temperature. TGA curve shows weight of the sample as a function of temperature in weight reduction. The obtained weight versus temperature data is typically plotted as a thermogram. Derivative thermogravimetry (DTG) curve is first derivative of the weight over the temperature which shows rate of the weight losses as a function of temperature. That is, if no weight loss takes place, DTG is close to zero; if TGA detects weight losses, DTG starts deviate from zero in positive direction indicating non-zero rate of the weight loss.

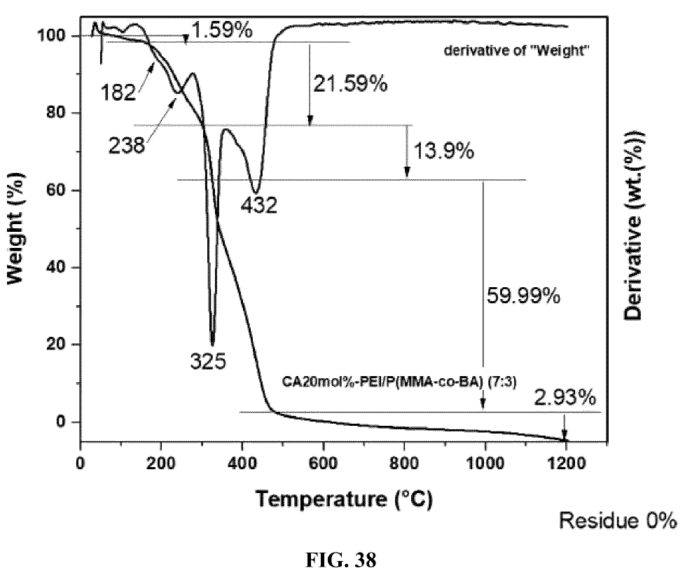

FIG. 38 shows weight loss profile obtained from TGA and DTG of the CA20 mol-PEI750k/P(MMA-co-BA) particles. The samples (4-7 mg) were placed in platinum pan and heated up to 1,200° C. at a rate of 10° C./min under nitrogen purge (30 mL/min). The thermogram reveals that the particles had five weight-loss stages: First Stage (80 to 120° C.): At the beginning of the TGA curve, there is a weight loss of 1.59% attributed to the evaporation and dehydration of adsorbed and surface water from the particles. Second Stage (180 to 280° C.): There is a gradual weight loss of 21.59%, which is attributed to the degradation of PEI. Third Stage (280 to 370° C.): The third stage is observed at around 325° C., with a weight loss of 13.90% according to the DTG curve. This stage is likely associated with the degradation of poly(MMA-co-BA) copolymer. Fourth Stage (370 to 500° C.): The fourth stage occurs at around 432° C., with a weight loss of 59.99% based on the DTG curve. This stage is also attributed to the degradation of poly(MMA-co-BA) copolymer based on the literature reports.

Fifth Stage (500 to 1200° C.): There is a weight loss of 2.93%, which is attributed to the carbon dots (CDs) present in the particles. Literature has reported that carbon dots exhibit relatively high thermal stability. The degradation temperature of carbon dots can range from a few hundred to several hundred degrees Celsius, depending on their specific composition, size, and surface passivation. Surface modifications or functionalization can enhance their thermal stability and increase the degradation temperature. According to the TGA findings, the particle's composition, excluding water, is as follows: 22% PEI, 75% P(MMA-co-BA) copolymer, and 3% carbon dots.

### Fluorescent Properties

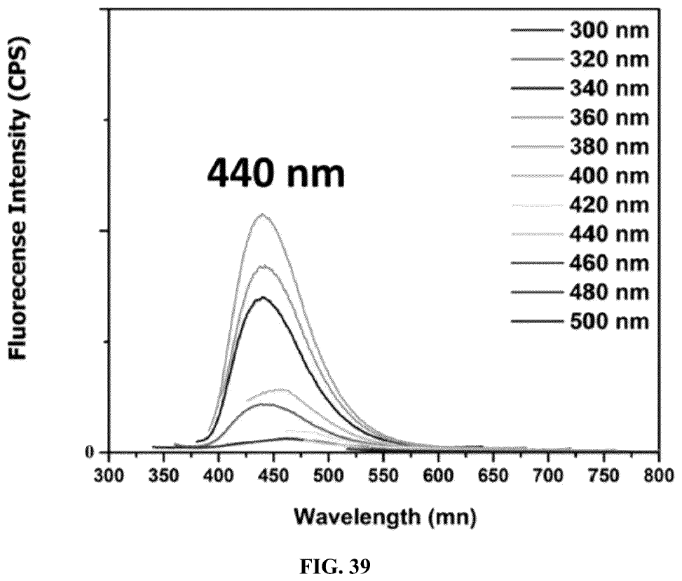

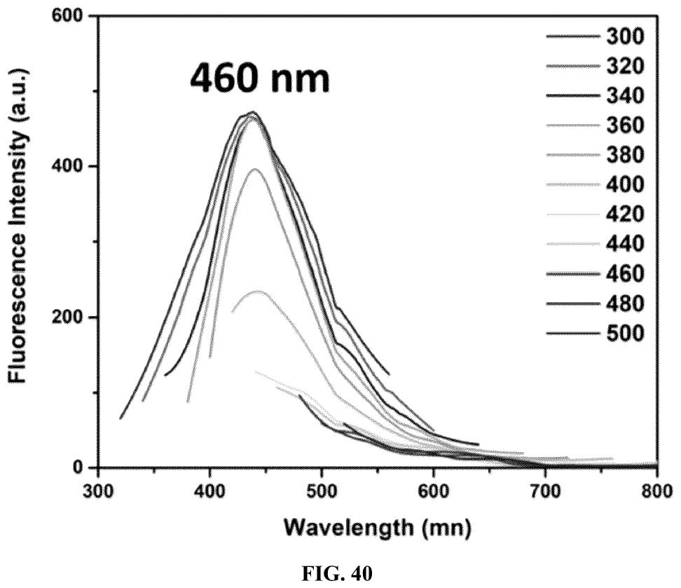

FIGS. 39 and 40 show the fluorescent spectra of CA20 mol %-PEI750k/P(MMA-co-BA) particles in aqueous dispersion and solid state, respectively. In aqueous dispersion, the particles emit c.a. 440 nm when excited by 320, 340, 360 and 380 nm light; while low fluorescent emission is observed when excited by 400-500 nm light. Among these excitation wavelengths, the highest fluorescent intensity is observed when the particles are excited by light at 360 nm.

When solid particles were subjected to excitation wavelengths of 300, 320, 340, and 360 nm, comparable fluorescent emission peaks were observed with similar intensities around 460 nm. However, when the solid particles were excited by light at 380 and 400 nm, the emission intensities at 470 nm and 480 nm, respectively, were relatively lower. Furthermore, increasing the excitation wavelength up to 500 nm led to a decrease in fluorescence intensity. The differences in the fluorescence properties of the CA20 mol %-PEI750k/P(MMAco-BA) particles in aqueous dispersion and solid-state can be attributed to the influence of water molecules and the formation of hydrogen bonds between the sub-fluorophore units and water. The change of these interactions leads to distinct fluorescence emission characteristics in different environments of the particles.

This disclosure focuses on the development of fluorescent core-shell particles using PEI based amphiphilic core-shell particles as nanoreactors for the synthesis of carbon dots (CDs). By investigating the crosslinking reaction between molecule containing two or three carboxylic acid groups and the PEI shell of PEI/polyacrylate particles, it was discovered that citric acid (CA) could act as a carbon source, leading to the formation of carbon dots within the PEI shell. These carbon dots were homogenously distributed on the PEI shell layer of the particles. Consequently, the core-shell particles modified with citric acid exhibited photoluminescent properties in water. Further optimization experiments were conducted, focusing on variables such as the molecular weight of PEI, the core-to-shell ratio of the particles, and the composition of the core. These experiments aimed to enhance the synthesis process and properties of the particles. As a result, water-dispersible PEI/poly(methyl methacrylate-co-butyl acrylate) [PEI/P(MMA-co-BA)] particles modified with citric acid (CA) were successfully synthesized. Comprehensive characterization was performed to evaluate the properties of the particles. Dynamic light scattering and zeta-potential measurements were utilized to determine particle size, size distribution, and surface charge. Fluorescence spectroscopy and quantum yield measurements were employed to assess the photoluminescence and quantum yield of the particles. Moreover, techniques such as FTIR (Fourier Transform Infrared Spectroscopy), SEM (Scanning Electron Microscopy), TEM (Transmission Electron Microscopy), and TGA (Thermogravimetric Analysis) were used to examine the chemical structure, particle morphology, and composition. The successful synthesis of these novel carbon dot-loaded fluorescent core-shell particles presents exciting opportunities for various applications, including coating, bioimaging, sensing, and energy-saving applications.

### Examples

### Synthesis of PEI-Based Amphiphilic Core-Shell Particles

The synthetic routes to prepare the polyethyleneimine/poly(methyl methacrylate) (PEI/PMMA) and polyethyleneimine/poly(methyl methacrylate-co-butyl acrylate) [PEI/P(MMA-co-BA)] core-shell particles in aqueous solution are illustrated in FIG. 1. For a typical 100 g batch reaction, the total solid content of the reaction was fixed at 10%. The PEI (2.17 to 6.67 g, PEI:monomer=1:3.6-1:0.5 wt/wt) was firstly dissolved in H₂O, then adjusting to pH 7 with 2 M HCl. The total mass of the solution was made up to 90 g by adding H₂O. The solution was then transferred to a water-jacketed flask equipped with a thermometer, a condenser, a magnetic stirrer, and a nitrogen inlet, and degassed for 15 minutes. TBHP solution and purified MMA and BA monomers were also degassed separately by purging N₂ for 15 minutes. The purified MMA or MMA/BA mixture (7.83 to 3.33 g, PEI:monomer=1:3.6-1:0.5 wt/wt) was added into the flask after PEI solution reached 80° C. Finally, 100 mM of TBHP solution (monomer:TBHP=1:355 mol/mol) was added into the mixture to initiate the polymerization, and allowed to react for 4 hours at 80° C. under nitrogen.

After the reaction, the unreacted monomers were removed by rotatory evaporation and particles were purified via dialysis against water (MWCO=12,500 Da) until the conductivity of dialysate was below 30 S/cm. The purified dispersions were stored at room temperature for subsequent treatment and characterization.

### Preparation of Organic Acid Solutions

A series of 10 wt % organic acid solutions (as indicated in FIG. 8) were prepared through the dissolution of respective solid organic acids in an aqueous medium. Specifically, 10 g of oxalic acid (OA), malic acid (MaA), citric acid (CA), and ethylenediaminetetraacetic acid (EDTA, 99%) were individually dissolved in 90 g of water using a combination of heat (70-90° C.) and sonication (200 W). On the other hand, 10 wt % solutions of succinic acid (SA), glutaric acid (GA), and maleic acid (MA) were prepared by hydrolyzing succinic anhydride (8.474 g), glutaric anhydride (9.09 g), and maleic anhydride (8.446 g) in water at a temperature of 90° C., continuing the process until complete dissolution of the solid compounds was achieved.

### Surface Modification of PEI-Based Amphiphilic Core-Shell Particles by Different Acids

To perform the modification of PEI25k/PMMA particles using various organic acids, a standard batch modification reaction with a total solid content of 2% was employed. In this process, 10 g of PEI25k/PMNMA particles dispersion (10 wt %) in an aqueous medium were mixed with the 10 g organic acids solution. Subsequently, the mixtures were adjusted to a total weight of 100 g by adding 80 g water. The resulting solutions were then transferred to a water-jacketed flask equipped with a magnetic stirrer, a condenser, and a thermometer. The modification reactions were carried out at a temperature of 90° C., allowing them to proceed for a duration of 24 hours.

After the reaction, the unreacted acids were removed via dialysis against ultrapure H₂O (MWCO=12,500 Da) until the conductivity of dialysate below 30 S/cm. The particles dispersions were stored at room temperature for further experiment and characterization.

In order to isolate the PEI-CA carbon dots (CDs) from the particles, a centrifuge (Dynamica Scientific Ltd., Velocity 14R Pro Versatile Centrifuge) was employed. The PEI-CA CDs were separated by subjecting the fluorescent particles to centrifugation at 14000 rpm and 0° C. for a duration of 30 minutes. To ensure thorough separation of all the nanodots, three consecutive centrifugation steps were performed.

### Measurement

### Fourier Transform Infrared (FTIR)

The Fourier transform infrared (FTIR) spectra of the particles were recorded on a Nicolet iS50 FT-IR spectrometer using a KBr disk method over the spectral range of 500-4000 cm⁻¹.

Dynamic light scattering (DLS) and zeta-potential measurement

To measurement the size and size distribution of the particles, samples were diluted to 1,000 ppm in Milli-Q water at its original pH and measured by dynamic light scattering (DLS) method using Malvern Zetasizer Nano ZS operated at room temperature at 173° detector angle. The obtained size and size distribution are the average of three measurements. For zeta-potential measurement, samples were diluted to 1,000 ppm with 1 mM NaCl at its original pH and then measured by dynamic light scattering (DLS) method using Malvern Zetasizer Nano ZS. The obtained zeta-potential values are the average of three measurements.

### Thermogravimetric Analysis (TGA)

Thermogravimetric (TGA) measurements were conducted using a Thermogravimetric analyzer/Differential Scanning Calorimeter (Mettler Toledo TGA/DSC3+). 3-8 mg of dried particles was added into a 70 μL alumina crucible without cover. The crucible is inserted into the furnace at room temperature and heated from 30 to 1200° C. with a gradient of 20° C./min under absent of O₂ by purging N2 with a flow rate of 50 mL/min.

### Transmission Electron Microscope (TEM)

The particle morphologies were observed with a transmission electron microscope (TEM, Jeol JSM-6335F) at an accelerating voltage of 120 kV. For the sample preparation, all the samples were diluted to 100 ppm, then 80 μL sample was placed on the cupper grid to dry naturally. After drying, the samples were stained by dropping 100 L of 0.5 wt % phosphotungstic acids (PTA). After 30 seconds, the droplet of PTA was removed, and the cupper grids were dried under air.

### Scanning Electron Microscope (SEM)

The particle morphologies were observed with a field emission scanning electron microscope (FE-SEM, Tescan MAIA3). For the sample preparation, 10 μL of 100 ppm samples in an aqueous were dried on a P-type silicon chip substrate (SPI,4136SC-AB) sticked on a metal sample holder using a conductive carbon adhesive tape, and followed by coating it with a thin layer of gold using an ion sputter coater (SEC, MCM-200) for 30 s.

### Photoluminescent Measurement

Measurement the of optical properties of the samples in aqueous solution were taken using Horiba FluoroMax-4 spectrofluorometer (HORIBA Scientific). Samples were diluted to 1,000 ppm via the addition of Milli-Q water and added into a 10 mm quartz cuvette for measurement.

Measurement the optical properties of the samples in solid state were taken on a LS-55 spectrofluorometer (PerkinElmer) equipped with front surface accessory. Adequate sample powder (≈1 mg) was placed in the silica window powder holder and measured.

In a typical fluorescence scanning measurement, the samples were scanned from 300 to 500 nm (excitation wavelength, λₑₓ) with a fixed increment of 20 nm; and the detected emission wavelength (emission wavelength, λₑₘ) was calculated by the following equation:

$${λ}_{em , lower limit} = {λ}_{ex} = 20 \\ {λ}_{em , upper limit} = \{ \begin{matrix}2 {λ}_{ex} - 40 , & {λ}_{em , upper limit} \leq 800 \\ 800 , & {λ}_{em , upper limit} > 800\end{matrix}$$

### Relative Quantum Yield (QY)

To determine the brightness of the samples in aqueous dispersion or solution. A method of measuring the relative quantum yield was adopted. The sample dispersions and the standard solution (quinine sulfate) with absorbances between 0.01-0.1 a.u. at 360 nm (measured by Agilent Technology Cary 8454 UV-Vis spectrometer) were acquired by a serial dilution using ultra-pure water and 0.5 M H2SO4 solution, respectively. The fluorescent emission spectra of the prepared dispersion or solution with absorbances between 0.01-0.1 a.u. at 360 nm were then measured by the Horiba FluoroMax-4 spectrofluorometer. The quantum yield of the sample was then calculated by using the slopes of the integrated intensity vs absorbance plot.

The quantum yield of the samples, QYₓ, was then calculated by the following equation:

$${QY}_{x} = Q {Y}_{s} \times \frac{{A}_{s}}{{A}_{x}} \times \frac{{F}_{x}}{{F}_{s}} \times \frac{{n}_{x}^{2}}{{n}_{s}^{2}} = {QY}_{s} \times \frac{{m}_{x}}{{m}_{s}} \times \frac{{n}_{x}^{2}}{{n}_{s}^{2}}$$

where QYₛ is the quantum yield of the standard, Aₓ and Aₛ are the absorbances of the sample and standard, respectively, Fₓ and Fₛ are the integrated fluorescent intensities of the sample and standard, respectively, nₓ and nₛ are the reflective indexes of the sample and standard, respectively, and mₓ and mₛ are the slopes of integrated fluorescent intensity vs absorbance plot of the sample and standard, respectively.

What is claimed is:

1. Fluorescent core-shell particles comprising a core, a first shell disposed on a surface of the core, and a second shell disposed on a surface of the first shell, wherein the core comprises a first polymer selected from a group consisting of a poly(alkyl acrylate), a poly(alkyl methacrylate), a poly(alkyl acrylamide), a polyacrylonitrile, a polyacetate, and copolymers thereof, the first shell comprises a first polyamine and a second polymer selected from a group consisting of a poly(alkyl acrylate), a poly(alkyl methacrylate), a poly(alkyl acrylamide), a polyacrylonitrile, a polyacetate, and copolymers thereof, and the second shell comprises a second polyamine and a plurality of carbon dots, wherein at least a portion of the first polyamine is grafted to the second polymer.

2. The fluorescent core-shell particles of claim 1, wherein each of the first polymer and the second polymer is independently selected from a poly(C₁-C₆ alkyl acrylate), poly(C₁-C₆ alkyl methacrylate), and a copolymer thereof.

3. The fluorescent core-shell particles of claim 1, wherein each of the first polymer and the second polymer is independently selected from a poly(methyl methylacrylate) and a poly(methyl methacrylate-co-butyl acrylate).

4. The fluorescent core-shell particles of claim 1, wherein each of the first polyamine and the second polyamine is independently selected from the group consisting of polyethyleneimine, chitosan, casein, gelatine, bovine serum albumin, and a mixture thereof.

5. The fluorescent core-shell particles of claim 1, wherein each of the first polyamine and the second polyamine is independently a polyethyleneimine having a weight average molecular weight of 1,000-1,000,000 kDa.

6. The fluorescent core-shell particles of claim 1, wherein each of the first polyamine and the second polyamine is independently a polyethyleneimine having a weight average molecular weight of 25,000-750,000 kDa.

7. The fluorescent core-shell particles of claim 1, wherein the plurality of carbon dots is prepared by hydrothermal treatment of an organic acid.

8. The fluorescent core-shell particles of claim 7, wherein the organic acid is selected from the group consisting of malic acid, maleic acid, tartaric acid, citric acid, an amino acid, ethylenediaminetetraacetic acid, HO₂C(CH2)ₘCO₂H, wherein m is whole number selected from 0-10, and mixtures thereof.

9. The fluorescent core-shell particles of claim 7, wherein the organic acid comprises citric acid.

10. The fluorescent core-shell particles of claim 1, wherein each of the first polymer and the second polymer is selected from a poly(methyl methylacrylate) and poly(methyl methacrylate-co-butyl acrylate); each of the first polyamine and the second polyamine is independently a polyethyleneimine having a weight average molecular weight of 1,000-1,000,000 kDa; and the plurality of carbon dots is prepared by hydrothermal treatment of an organic acid selected from the group consisting of malic acid, maleic acid, tartaric acid, citric acid, an amino acid, ethylenediaminetetraacetic acid, HO₂C(CH2)ₘCO₂H, wherein m is whole number selected from 0-10, and mixtures thereof.

11. The fluorescent core-shell particles of claim 1, wherein each of the first polymer and the second polymer is selected from a poly(methyl methylacrylate) and a poly(methyl methacrylate-co-butyl acrylate); each of the first polyamine and the second polyamine is independently a polyethyleneimine having a weight average molecular weight of 25,000-750,000 kDa; and the plurality of carbon dots are prepared by hydrothermal treatment of oxalic acid, malic acid, citric acid, ethylenediaminetetraacetic acid, succinic acid, glutaric acid, maleic acid, or a mixture thereof.

12. The fluorescent core-shell particles of claim 11, wherein the plurality of carbon dots is prepared by hydrothermal treatment of citric acid.

13. The fluorescent core-shell particles of claim 7, wherein the hydrothermal treatment of the organic acid is conducted in the presence of core-shell particle precursors comprising a first shell disposed on a surface of a core, and a second shell disposed on a surface of the first shell, wherein the core comprises a first polymer selected from a group consisting of a poly(alkyl acrylate), a poly(alkyl methacrylate), and copolymers thereof, and the second shell comprises a second polyamine and a second polymer selected from a group consisting of a poly(alkyl acrylate), a poly(alkyl methacrylate), and copolymers thereof, wherein at least a portion of the second polyamine is grafted to the second polymer, wherein the organic acid is contacted with the core-shell particle precursors at 10-30 mol % of organic acid relative to the polyamine present in the core-shell particle precursors.

14. The fluorescent core-shell particles of claim 1, wherein each of the first polymer and the second polymer are a poly(methyl methylacrylate), each of the first polyamine and the second polyamine is polyethyleneimine, and the fluorescent core-shell particles comprise polyethyleneimine and the poly(methyl methylacrylate) in a weight ratio of about 1 to about 0.5, respectively; or each of the first polymer and the second polymer are a poly(methyl methacrylate-co-butyl acrylate), each of the first polyamine and the second polyamine is polyethyleneimine, and the fluorescent core-shell particles comprise polyethyleneimine and the poly(methyl methacrylate-co-butyl acrylate) in a weight ratio of about 1 to about 0.5, respectively.

15. The fluorescent core-shell particles of claim 1, wherein each of the first polymer and the second polymer are a poly(methyl methacrylate-co-butyl acrylate) comprising methyl methacrylate and butyl acrylate in a weight ratio between 9:1 to 1:1, respectively.

16. The fluorescent core-shell particles of claim 12, wherein the hydrothermal treatment of citric acid is conducted in the presence of core-shell particle precursors comprising a first shell disposed on a surface of a core, and a second shell disposed on a surface of the first shell, wherein the core comprises a poly(methyl methacrylate-co-butyl acrylate); the second shell comprises polyethyleneimine and poly(methyl methacrylate-co-butyl acrylate); and the second shell comprises polyethyleneimine, wherein at least a portion of the polyethyleneimine in the second shell is grafted to the poly(methyl methacrylate-co-butyl acrylate) in the first shell, wherein the citric is contacted with the core-shell particle precursors at about 20 mol % of citric acid relative to the polyethyleneimine present in the core-shell particle precursors.

17. A method of preparing the fluorescent core-shell particles of claim 1, the method comprising:
contacting a first olefin selected from an alkyl acrylate, an alkyl methacrylate an alkyl acrylamide, vinyl nitrile, and a vinylacetate, optionally a second olefin selected from an alkyl acrylate, an alkyl methacrylate, an alkyl acrylamide, vinyl nitrile, and a vinylacetate, a polyamine, and a radical initiator thereby forming core-shell particle precursors comprising: a first shell disposed on a surface of a core and a second shell disposed on a surface of the first shell, wherein the core comprises a first polymer selected from a group consisting of a poly(alkyl acrylate), a poly(alkyl methacrylate), a poly(alkyl acrylamide), a polyacrylonitrile, a polyacetate, and copolymers thereof, the first shell comprises the polyamine and a second polymer selected from a group consisting of a poly(alkyl acrylate), a poly(alkyl methacrylate), a poly(alkyl acrylamide), a polyacrylonitrile, a polyacetate, and copolymers thereof; and the second shell comprises the polyamine, wherein at least a portion of the polyamine in the first shell is grafted to the second polymer;
contacting the core-shell particle precursors with an organic acid thereby forming a reaction mixture; and
subjecting the reaction mixture to hydrothermal conditions resulting in the formation of the plurality of carbon dots in the second shell and thereby forming the fluorescent core-shell particles.

18. The method of claim 17, wherein each of the first olefin and the second olefin is independently selected from the group consisting of a C₁-C₆ alkyl acrylate and a C₁-C₆ alkyl methacrylate.

19. The method of claim 17, wherein the polyamine is selected from the group consisting of polyethyleneimine, chitosan, casein, gelatine, bovine serum albumin, and a mixture thereof.

20. The method of claim 17, wherein the organic acid is selected from the group consisting of malic acid, maleic acid, tartaric acid, citric acid, an amino acid, ethylenediaminetetraacetic acid, HO₂C(CH2)ₘCO₂H, wherein m is whole number selected from 0-10, and mixtures thereof.

21. The method of claim 17, wherein the polyamine is first olefin is methyl methacrylate, the second olefin is butyl acrylate and the methyl methacrylate and the butyl acrylate are contacted in a weight ratio between 9:1 to 1:1, respectively; and the polyamine and the methyl methacrylate and butyl acrylate are contacted in a weight ratio of total weight of methyl methacrylate and butyl acrylate to polyethyleneimine of about 1 to about 0.5, respectively; or
the first olefin is methyl methacrylate and the second olefin is not present and the polyamine and the methyl methacrylate are contacted in a weight ratio of methyl methacrylate to polyamine of about 1 to about 0.5, respectively.

22. The method of claim 17, wherein the polyamine is polyethyleneimine, the organic acid is citric acid, and the citric acid is contacted with the with the core-shell particle precursors at about 20 mol % of citric acid relative to the polyethyleneimine present in the core-shell particle precursors.
